(19) United States
(12) Patent Application Publication
(10) Pub. No.: US 2026/0103937 A1
(43) Pub. Date: Apr. 16, 2026

(54) METHOD FOR OPERATING A DOOR OPENING APPARATUS, DOOR OPENING APPARATUS AND REFRIGERATION APPLIANCE

(71) Applicant: BSH Hausgeräte GmbH, Müchen (DE)

(72) Inventors: Martin SCHIMMELE, Unterschneidheim (DE); Matthias HAGMAYER, Dischingen (DE); Michael SCHNEIDER, Hafenhofen (DE)

(21) Appl. No.: 19/351,349

(22) Filed: Oct. 7, 2025

(30) Foreign Application Priority Data
Oct. 10, 2024 (DE) 102024209852.3
Oct. 10, 2024 (DE) 102024209853.1

(51) Int. Cl. E05F 15/616

(52) U.S. Cl. CPC E05F 15/616; E05Y 2201/422; E05Y 2900/31

(57) ABSTRACT

A method is provided for operating a door opening apparatus for a refrigeration appliance. The door opening apparatus includes at least one plunger to open at least one refrigeration appliance door of the refrigeration appliance. In at least one detection step, a pressure is detected in an interior space of the refrigeration appliance, in particular by a sensor unit of the door opening apparatus. In at least one analysis step, at least one position of the at least one plunger of the door opening apparatus is determined as a function of the detected pressure, providing improved properties with respect to operating convenience and/or efficiency of use. A door opening apparatus and a refrigeration appliance are also provided.

### CROSS-REFERENCE TO RELATED APPLICATION

This application claims the priority, under 35 U.S.C. § 119, of German Patent Applications DE 10 2024 209 853.1 and DE 10 2024 209 852.3, both filed Oct. 10, 2024; the prior applications is herewith incorporated by reference in its entirety.

### FIELD AND BACKGROUND OF THE INVENTION

The invention relates to a method for operating a door opening apparatus for a refrigeration appliance, a door opening apparatus and a refrigeration appliance.

A door opening apparatus for a refrigerator is already known from the prior art, for example German Patent Application DE 10 2006 061 083 A1, corresponding to U.S. Pat. No. 9,062,911 B2, wherein a pressure is detected by a sensor unit within the refrigeration appliance, wherein as a function of the detected pressure a refrigeration appliance door is opened by a movable plunger of the door opening apparatus. European Application EP 4 172 542 A1, corresponding to U.S. Publication No. 2023/0296306 A1, discloses a method for operating a refrigeration appliance, wherein a pressure of an interior space of the refrigeration appliance is detected in at least one detection step, wherein the detected pressure is evaluated in at least one analysis step by at least one evaluation unit of the refrigeration appliance, and wherein, in the at least one analysis step, only an open and/or closed state of the interior space of the refrigeration appliance is identified as a function of the detected pressure.

### SUMMARY OF THE INVENTION

It is accordingly an object of the invention to provide a method for operating a door opening apparatus, a door opening apparatus and a refrigeration appliance. which overcome the hereinafore-mentioned disadvantages of the heretofore-known methods and devices of this general type and in which a generic method is provided with improved properties with respect to operating convenience and efficiency of use.

With the foregoing and other objects in view there is provided, in accordance with the invention, a method for operating a door opening apparatus for a refrigeration appliance, in particular a refrigerator, wherein the door opening apparatus comprises at least one plunger so as to open at least one refrigeration appliance door of the refrigeration appliance, wherein a pressure within the refrigeration appliance is detected in at least one detection step of the method, in particular by at least one sensor unit of the door opening apparatus.

It is proposed that, in at least one analysis step of the method, at least one position of the at least one plunger of the door opening apparatus is determined in particular by an evaluation unit of the door opening apparatus as a function of the detected pressure.

Such an embodiment renders it possible to determine a position of the plunger of the door opening apparatus in an advantageously simple and precise manner. As a result, it is possible to achieve an advantageously high level of operating convenience, since in particular a risk of incorrectly determining the position of the plunger can be kept advantageously low. Furthermore, it is possible to achieve an advantageously high level of system efficiency and/or energy efficiency, since in particular by precisely determining the position of the plunger it is possible to advantageously precisely control functions of the refrigeration appliance as a function of the position of the plunger. Moreover, it is possible to achieve an advantageously high level of cost efficiency, since in particular sensors for detecting a pressure are advantageous in terms of purchase price. Moreover, complexity can be kept advantageously low, since the detected pressure can be used both for detecting an activation of the door opening apparatus and for determining the position of the plunger. As a result, it is possible to achieve an advantageously high level of efficiency of use.

It is preferred that, in the at least one detection step, a pressure, in particular a pressure change is detected which is generated by a movement of the refrigeration appliance door of the refrigeration appliance in particular by an operator or the door opening apparatus of the refrigeration appliance. It is preferred that, in the at least one detection step, the pressure is detected with a scanning rate of a minimum 10 Hz, advantageously of a minimum 20 Hz particularly advantageously of a minimum 50 Hz, preferably of a minimum 100 Hz, particularly preferably of a minimum 200 Hz. It is preferred that, in the at least one detection step, the pressure is detected with a scanning rate of a maximum 1000 Hz, advantageously a maximum 750 Hz, particularly advantageously a maximum 500 Hz, preferably a maximum 500 Hz, preferably a maximum 250 Hz. It is preferred that, in the at least one detection step, an absolute pressure is detected in the interior space of the refrigeration appliance. Alternatively, it is conceivable that, in the at least one detection step, a relative pressure or a differential pressure is detected, in particular relative to the atmospheric pressure at the installation site of the refrigeration appliance.

It is preferred that the method has at least one door opening step. In the at least one door opening step, it is preferred that the at least one refrigeration appliance door is opened by the at least one plunger from a closed position of the at least one refrigeration appliance door. In the at least one door opening step, the at least one plunger is preferably moved from a retracted position of the at least one plunger toward the at least one refrigeration appliance door in order to open the at least one refrigeration appliance door in particular. Moreover, it is preferred that the method has at least one plunger retraction step. In the at least one plunger retraction step, the at least one plunger is moved from an extended position to the retracted position in order to enable closing the refrigeration appliance door by an operator and/or a reset element of the refrigeration appliance, in particular without the refrigeration appliance door striking the plunger. It is preferred that, in the at least one door opening step and/or the at least one plunger retraction step, the at least one plunger is driven by at least one drive unit of the door opening apparatus. It is preferred that the at least one door opening step is initiated by an operator input, for example by an actuating element of the refrigeration appliance or by a pressure change generated in the at least one interior space of the refrigeration appliance by the operator. It is preferred that the operator input is evaluated by the at least one evaluation unit and a control signal is transmitted to the at least one drive unit so as to perform the at least one door opening step. It is preferred that the at least one plunger retraction step is initiated at a point in time in which the at least one plunger is extended to a predetermined position, for example a maximum extended position of the at least one plunger, and/or in which the at least one plunger is held for a predetermined period of time at the predetermined position.

It is preferred that through the use of the at least one door opening step of the method, in particular through the use of the effect of force of the at least one plunger on the at least one refrigeration appliance door, a pressure change is generated in the at least one interior space. It is preferred that, in the at least one analysis step, a prevailing position of the at least one plunger of the door opening apparatus at the at least one refrigeration appliance door of the refrigeration appliance, in particular at a stop surface of the refrigeration appliance door, is determined as a function of the detected pressure. The expression a “prevailing position of the at least one plunger at the at least one refrigeration appliance door” is to be understood to mean that at least a part of the at least one plunger, in particular a part of the at least one plunger facing the at least one refrigeration appliance door, contacts the at least one refrigeration appliance door at least at one point.

It is preferred that, in the at least one analysis step of the method, an open state of the refrigeration appliance, in particular a state of the refrigeration appliance, in particular of the at least one interior space, not closed by the at least one refrigeration appliance door, is determined in particular by the at least one evaluation unit as a function of the detected pressure. It is preferred that, in the at least one analysis step, opening the refrigeration appliance door of the refrigeration appliance is identified in particular by the evaluation unit as a function of the detected pressure. It is preferred that the interior space of the refrigeration appliance is in a state closed by the refrigeration appliance door in order to determine a subsequent opening of the refrigeration appliance door and/or the position of the plunger by the at least one analysis step. In particular, when opening the refrigeration appliance door, a pulling force or a pushing force is exerted on the refrigeration appliance door by a user or the door opening apparatus in order to open the refrigeration appliance door. In particular, through the use of a sealing element of the refrigeration appliance, preferably before the sealing element detaches from the refrigeration appliance door or a body of the refrigeration appliance, a volume of the interior space is increased by the sealing element expanding, resulting in a pressure reduction in the interior space. In particular, the detected pressure increases again if the sealing element detaches from the refrigeration appliance door or the body until the detected pressure corresponds to the ambient pressure, in particular the atmospheric pressure, at the installation site of the refrigeration appliance. It is preferred that this process described above is evaluated in the at least one analysis step by the evaluation unit so as to identify the opening of the refrigeration appliance door and/or the position of the at least one plunger of the door opening apparatus.

It is preferred that, in the at least one analysis step, a state of the at least one interior space of the refrigeration appliance closed by the at least one refrigeration appliance door is determined as a function of the detected pressure. It is preferred that closing the refrigeration appliance door is identified in the at least one analysis step as a function of the detected pressure. It is preferred that the interior space is in a state opened by the refrigeration appliance door, in particular not closed, in order to identify a subsequent closing of the refrigeration appliance door in the at least one analysis step. It is preferred that the detected pressure in the state of interior space opened by refrigeration appliance door corresponds to the ambient pressure, in particular to the atmospheric pressure, at the installation site of the refrigeration appliance. In particular, when closing the refrigeration appliance door, a pushing force is exerted on the refrigeration appliance door by a user of the refrigeration appliance or by a reset element of the refrigeration appliance in order to close the refrigeration appliance door. In particular, at a point in time in which a sealing element, in particular the one mentioned above, of the refrigeration appliance comes into contact with the refrigeration appliance door or a body of the refrigeration appliance, a volume of the interior space is reduced by the sealing element compressing, resulting in an increase in pressure in the interior space. In particular, the detected pressure drops again if the sealing element returns to its original shape. It is preferred that this process described above is evaluated in the at least one analysis step by the evaluation unit for identifying a closing of the refrigeration appliance door.

It is preferred that, in the at least one analysis step, the at least one position of the at least one refrigeration appliance door and/or the at least one plunger is determined as a function of an in particular positive and/or negative change in the detected pressure. It is preferred that the at least one position of the at least one refrigeration appliance door and/or the at least one position of the at least one plunger is determined as a function of exceeding and/or falling below at least one predetermined pressure threshold value of the detected pressure or the filtered pressure. In particular, the predetermined pressure threshold value is a pressure value which is preferably 25% or advantageously 20% or particularly advantageously 15% or preferably 10% or particularly preferably 5% less or greater than a pressure reference value, for example an atmospheric pressure, in particular at the installation site of the refrigeration appliance. The pressure reference value and/or the at least one predetermined pressure threshold value can be stored in a storage facility of a storage facility unit of the evaluation unit. It is preferred that, in at least one pressure threshold value determination step of the method, the at least one predetermined pressure threshold value is determined in particular by the evaluation unit as a function of the pressure reference value.

It is preferred that, in at least one calculating step of the method, a sliding mean value of the detected pressure is formed in particular by the evaluation unit so as to determine the pressure reference value. As a result, it is advantageously possible to take into consideration any influence, for example, of a temperature change in the interior space of the refrigeration appliance when evaluating the detected pressure. As a result, a risk of incorrectly determining the position of the plunger is kept advantageously low. It is preferred that, in the calculating step, a sliding mean value, preferably at least of the last five values, advantageously at least of the last four values and preferably at least of the last three values of the detected pressure, is formed in particular by the at least one evaluation unit. The sliding mean value of the detected pressure formed in the at least one calculating step is preferably used as a pressure reference value so as to determine the at least one pressure threshold value in the at least one pressure threshold value determination step.

It is conceivable that, in order to set the at least one predetermined pressure threshold value, the pressure threshold value determination step of the method is performed once after an initial commissioning of the refrigeration appliance at the installation site or once per day, for example every 24 hours. It is preferred that the at least one pressure threshold value determination step is performed once an hour, advantageously once every 10 minutes, particularly advantageously once a minute, preferably once a second. It is particularly preferred that the pressure threshold value determination step is performed after each calculating step in order to dynamically determine in particular the at least one pressure threshold value as a function of the sliding mean value of the detected pressure. It is preferred that, in the at least one pressure threshold value determination step, at least one predetermined constant value is added to or subtracted from the sliding mean value in order to determine the at least one pressure threshold value. Alternatively, in the at least one pressure threshold value determination step, a percentage value of the sliding mean value is determined and added to the sliding mean value or subtracted from the sliding mean value in order to determine the at least one pressure threshold value.

Advantageously, in the at least one analysis step, a prevailing position of the at least one plunger is determined if the detected pressure falls below a plunger position threshold value determined by the at least one pressure threshold value determination step in particular after the at least one door opening step has been initiated. It is preferred that the plunger position threshold value is set in the at least one pressure threshold value determination step at least at 0.1 Pa less, advantageously at least at 0.2 Pa less, particularly advantageously at least at 0.3 Pa less, preferably at least at 0.5 Pa less than the pressure reference value. It is preferred that the plunger position threshold value is set in the at least one pressure threshold value determination step at a maximum 1.5 Pa, advantageously at a maximum 1 Pa, less than the pressure reference value.

Alternatively, it is conceivable that a difference quotient or a derivative of the detected pressure is formed in the at least one analysis step of the method. In this alternative embodiment of the method, it is preferred that, in the at least one analysis step, the at least one position of the at least one refrigeration appliance door and/or the at least one plunger is determined by falling below and/or exceeding a difference quotient threshold value or a derivative threshold value.

It is further proposed that, in the at least one analysis step of the method, a door opening position of the at least one plunger is determined in particular by the at least one evaluation unit as a function of the detected pressure. Such an embodiment renders it possible to determine an advantageously minimum spacing between the refrigeration appliance door and the plunger for a start position of the at least one plunger, in particular so as to initiate the door opening step, which leads in particular to an advantageously small empty stroke of the plunger during the door opening step. This renders possible an advantageously high level of operating convenience, since it is possible to achieve in particular an advantageously short duration of the door opening step. The expression a “door opening position of the at least one plunger” is to be understood to mean preferably a position of the at least one plunger between a completely retracted position of the at least one plunger and a stop position of the at least one plunger at the at least one refrigeration appliance door in a closed position of the at least one refrigeration appliance door, which is used in particular as a start position and end position of a movement of the at least one plunger so as to open the at least one refrigeration appliance door. It is preferred that the door opening position of the at least one plunger has a spacing between an end of the at least one plunger facing the at least one refrigeration appliance door, and a stop surface of the at least one refrigeration appliance door facing the at least one plunger of in particular a maximum 7 mm, advantageously a maximum 5 mm, particularly advantageously a maximum 3 mm, preferably a maximum 1 mm and particularly preferably a maximum 0.5 mm. It is preferred that the at least one plunger is located in a completely retracted state at the start of the at least one door opening step of the method, in particular when performing the at least one door opening step prior to performing for the first time the at least one analysis step. It is preferred that the determined door opening position is set as a new start position of the at least one plunger in the case of a renewed performance of the at least one door opening step. It is preferred that the determined door opening position is set as a new end position of the plunger in the case of a renewed performance of the at least one plunger retraction step. It is preferred that the at least one plunger remains in the door opening position after a performance of the at least one plunger retraction step until the next performance of the at least one door opening step. It is preferred that the door opening position of the at least one plunger is determined in the at least one analysis step as a function of a positive and/or negative pressure change. It is preferred that, in the at least one analysis step, the door opening position is determined as a function of a detected event of falling below a plunger position threshold value, in particular the one mentioned above.

Furthermore, it is proposed that, in the at least one analysis step, a door opening position, in particular the one mentioned above, of the at least one plunger is determined as a function of falling below, in particular crossing, an opening threshold value. Such an embodiment renders it possible to determine the door opening position advantageously precisely, whereby it is possible in particular to determine an advantageously minimum spacing between the refrigeration appliance door and the plunger for a start position of the at least one plunger, in particular so as to initiate the door opening step, which leads in particular to an advantageously small empty stroke of the plunger during the door opening step. In particular, a risk of incorrectly determining the door opening position can be kept advantageously low, since the door opening position is determined as a function of opening the refrigeration appliance door. As a result, it is possible to achieve an advantageously high level of operating convenience. The opening threshold value is preferably determined in the at least one pressure threshold determination step as a function of a pressure reference value, in particular the one mentioned above, in particular as a function of the sliding mean value of the detected pressure. It is preferred that the opening threshold value is set in the at least one pressure threshold value determination step, in particular by the evaluation unit, at least at 0.5 Pa, advantageously at least at 0.6 Pa, particularly advantageously at least at 0.7 Pa, preferably at least at 0.8 Pa, and particularly preferably at least at 1 Pa, less than the pressure reference value. It is preferred that the door opening position is determined as a function of crossing the opening threshold value within an opening time interval. It is preferred that the opening time interval is stored in a storage facility of a storage facility unit of the evaluation unit. It is preferred that the opening time interval includes a time period of a maximum 2° s, advantageously a maximum 1,5 s, preferably a maximum 1 s and particularly preferably a maximum 0,5 s. It is preferred that the opening time interval has a time period of a minimum 0,05° s, advantageously a minimum 0,1 s. It is preferred that, in the at least one analysis step, opening the refrigeration appliance door is identified if the detected pressure falls below the opening threshold value. It is preferred that, in the at least one analysis step, opening the refrigeration appliance door is identified if the detected pressure crosses the opening threshold value within the opening time interval. It is preferred that the door opening position is determined in the analysis step if opening the refrigeration appliance door is identified in the at least one analysis step, in particular by the at least one evaluation unit.

The expression that “a detected pressure crosses a pressure threshold value within a time interval” is to be understood to mean in particular that within the time interval the detected pressure exceeds the pressure threshold value once and falls below it once. It is preferred that the detected pressure first falls below the pressure threshold value and subsequently exceeds the pressure threshold value within the time interval or the detected pressure first exceeds the pressure threshold value and subsequently falls below the pressure threshold value within the time interval.

Moreover, it is proposed that, in the at least one analysis step, a door opening position, in particular the one mentioned above, of the at least one plunger is determined as a function of a time period between falling below a pressure threshold value, in particular the one mentioned above, and a subsequent minimum of the detected pressure. Such an embodiment renders it possible to determine the door opening position of the plunger advantageously precisely, whereby it is possible to determine in particular an advantageously minimum spacing between the refrigeration appliance door and the plunger for a start position of the at least one plunger, in particular so as to initiate the door opening step, whereby it is possible to provide in particular an advantageously high level of operating convenience. It is preferred that, in the at least one pressure threshold value determination step, the pressure threshold value is set equal to the plunger position threshold value. Alternatively, in the at least one pressure threshold value determination step, the pressure threshold value is set equal to the pressure reference value, in particular equal to the sliding mean value of the detected pressure. In the at least one analysis step, it is preferable to detect a point in time of initiating the door opening step, a further point in time of falling below the pressure threshold value and an additional point in time of achieving the minimum of the detected pressure by the at least one evaluation unit. It is preferred that a time period between the further point in time of falling below the pressure threshold value and the additional point in time of achieving the minimum of the detected pressure is a maximum 2 s, advantageously a maximum 1.5 s, preferably a maximum 1 s and particularly preferably a maximum 0.5 s. It is preferred that, in the at least one analysis step, the at least one evaluation unit determines the door opening position by the point in time of initiating the door opening step, the further point in time of falling below the pressure threshold value and the additional point in time of achieving the minimum of the detected pressure and a movement speed of the at least one plunger.

It is further proposed that, in the at least one plunger movement step of the method, the at least one plunger of the door opening apparatus is moved to the determined door opening position, in particular by the at least one drive unit of the door opening apparatus. Such an embodiment renders it possible to achieve an advantageously minimum spacing between the refrigeration appliance door and the plunger when initiating the door opening step, which leads in particular to an advantageously small empty stroke of the plunger during the door opening step. This renders possible an advantageously high level of operating convenience, since in particular it is possible to provide an advantageously short duration of the door opening step and a noise development by a no longer required empty stroke. It is preferred that the at least one plunger movement step is initiated in terms of time after the at least one plunger retraction step, in particular by the at least one evaluation unit. In particular, the at least one plunger is moved in the at least one plunger movement step from the completely retracted position of the at least one plunger to the door opening position, in particular by the at least one drive unit. However, it would also be conceivable that the plunger movement step is initiated after the door opening step, in particular by the at least one evaluation unit in order in particular to move the plunger out of a completely extended position to the determined door opening position. It is preferred that the determined door opening position is set as a new start position of the at least one plunger in the case of a renewed performance of the at least one door opening step. It is preferred that the determined door opening position is set as a new end position of the plunger in the case of a renewed performance of the at least one plunger retraction step. It is preferred that the at least one plunger remains in the door opening position after a performance of at least one plunger retraction step until the next performance of the at least one door opening step.

Furthermore, it is proposed that in the door opening position of the at least one plunger, a spacing between one end of the at least one plunger and a contact surface of the at least one refrigeration appliance door is a maximum 7 mm. Such an embodiment renders it possible to provide an advantageously minimum spacing between the refrigeration appliance door and the plunger, wherein in particular furthermore a closed state of the refrigeration appliance door is rendered possible. It is preferred that the door opening position of the at least one plunger has a spacing between the one end of the at least one plunger and the stop surface of the at least one refrigeration appliance door of in particular a maximum 7 mm, advantageously a maximum 5 mm, particularly advantageously a maximum 3 mm, preferably a maximum 1 mm and particularly preferably a maximum 0.5 mm. It is preferred that the door opening position of the at least one plunger has a minimum spacing between the end of the at least one plunger and the stop surface of the at least one refrigeration appliance door of in particular a minimum 0.001 mm, advantageously a minimum 0.005 mm, particularly advantageously a minimum 0.01 mm, preferably a minimum 0.05 mm. As a result, if the plunger and the refrigeration appliance door have a minimum spacing, it is possible to advantageously counteract a risk of an incorrect function, for example incorrectly detecting the pressure and the resultant determination of the position of the refrigeration appliance door or the position of the plunger.

Moreover, it is proposed that, in at least one control step of the method, at least one functional capability of the door opening apparatus, in particular opening the at least one refrigeration appliance door by the at least one plunger is monitored as a function of the detected pressure, in particular by the at least one evaluation unit. Such an embodiment renders it advantageously possible to monitor a functional capability of the door opening apparatus. In particular, as a result, a user can be informed as to whether the door opening apparatus is completely functional or that maintenance may be required. As a result, it is possible to achieve an advantageously high level of operating convenience. It is preferred that a pressure change in the at least one interior space of the refrigeration appliance, which must have been generated by opening the at least one refrigeration appliance door by the plunger, is monitored in the at least one control step. In particular, monitoring is performed in the at least one control step as to whether when, initiating the at least one door opening step, opening the at least one refrigeration appliance door is identified. It is preferred that, in the at least one control step, an incorrect function of the door opening apparatus is identified as a function of the detected pressure. It is preferred that, in the at least one control step, in the case of an identified incorrect function of the door opening apparatus, a control signal is transmitted from the at least one evaluation unit to an output unit of the door opening apparatus or an output unit of the refrigeration appliance in order to output a warning signal by the output unit to a user. The warning signal is configured, for example, as a warning sound or as a message.

Furthermore, it is proposed that, in the at least one function adaptation step of the method, a function of the refrigeration appliance is regulated in particular by the at least one evaluation unit as a function of the position of the at least one plunger which is determined in particular by the at least one evaluation unit. Such an embodiment renders possible an advantageously high level of energy efficiency, in particular due, for example, to an adaptation of different operating modes of the refrigeration appliance as a function of the determined position of the plunger. This renders possible an advantageously high level of operating convenience, since it counteracts in particular a disadvantageous use of the refrigeration appliance. It is preferred that, in the at least one function adaptation step, a power of the refrigeration appliance, in particular a component of the refrigeration appliance, for example a compressor or a fan, is regulated as a function of the determined position of the at least one plunger and/or the position of the at least one refrigeration appliance door. Alternatively or additionally, it would be conceivable that, in the at least one function adaptation step, an operating program, for example a cooling program or a defrosting program, is interrupted or activated as a function of the determined position of the at least one plunger and/or the position of the at least one refrigeration appliance door. Alternatively or additionally, it would be conceivable that, in the at least one function adaptation step of the method, a function or an operating program of the refrigeration appliance is made inaccessible or non-executable for an operator as a function of the determined position of the at least one plunger and/or the position of the at least one refrigeration appliance door.

Furthermore, it is proposed that, in at least one movement adaptation step of the method, at least one movement parameter of the at least one plunger is regulated as a function of a determined position of the at least one plunger, in particular by the at least one evaluation unit. Such an embodiment renders possible an advantageously high level of operating convenience. In particular, the amount of noise generated can be kept advantageously small. Moreover, it is possible in particular to keep the amount of time required for opening the refrigeration appliance door by the plunger advantageously short. Furthermore, an advantageously long service life of mechanical components of the door opening apparatus can be achieved. It is preferred that, in the at least one movement adaptation step, a speed or acceleration of the at least one plunger when retracting and/or extending the plunger is regulated as a function of the determined position of the at least one plunger. Preferably, the at least one evaluation unit generates a control signal adapted to the at least one drive unit as a function of the determined position of the at least one plunger, in order to regulate in particular the speed or the acceleration of the plunger that is driven by the at least one drive unit. It is preferred that, in the movement adaptation step, when the at least one plunger is in a position not in contact with the at least one refrigeration appliance door, the speed or the acceleration of the at least one plunger is regulated to a value of preferably 60%, advantageously 50%, particularly advantageously 40%, preferably 30% and particularly preferably 20% of a maximum speed or a maximum acceleration of the plunger. It is preferred that, in the movement adaptation step, the speed or the acceleration of the at least one plunger when it is identified that the at least one plunger is in contact plunger with the at least one refrigeration appliance door is regulated to a value of preferably at least 70%, advantageously at least 80%, particularly advantageously at least 85%, preferably at least 95% and particularly preferably 100% of a maximum speed or a maximum acceleration of the plunger.

With the objects of the invention in view, there is also provided a door opening apparatus, in particular the one mentioned above, for a refrigeration appliance, in particular the one mentioned above, with at least one drive unit, in particular the one mentioned above, with at least one plunger, in particular the one mentioned above and which can be driven by the at least one drive unit so as to open a refrigeration appliance door, in particular the one mentioned above, of the refrigeration appliance, with at least one sensor unit for detecting a pressure of an interior space, in particular the one mentioned above, of the refrigeration appliance, and with at least one evaluation unit for evaluating the detected pressure in order to determine a position of the at least one plunger, in particular in accordance with the method described above.

The term a “door opening apparatus” is to be understood to mean in particular an apparatus for automatically, at least in part, opening at least one refrigeration appliance door of a refrigeration appliance. It is preferred that the door opening apparatus forms at least a part, in particular a sub-assembly, of the refrigeration appliance. In addition, it would be conceivable that the door opening apparatus is constructed as a separate module to the refrigeration appliance. It is preferred that the door opening apparatus can be retrofitted to a refrigeration appliance.

It is preferred that the at least one plunger is configured in the shape of a rod. In particular, a length of the plunger is greater than a width and a height of the plunger. It is preferred that the at least one plunger has a circular cross-section. Alternatively, it is conceivable that the plunger has a square or oval or elliptical cross-section. It is preferred that the at least one plunger has a shape of a straight line in a main extent direction of the at least one plunger. Alternatively, it is conceivable that the at least one plunger has a curvature or bend with respect to the main extent direction of the at least one plunger. For example, the at least one plunger is made of a metal and/or a synthetic material and/or a glass and/or a composite material.

The term a “main extent direction” of an object is to be understood to mean in particular a direction that runs parallel to a longest edge of a smallest geometric cuboid that just completely encloses the object.

It is preferred that the at least one door opening apparatus has at least one housing unit. It is preferred that the at least one drive unit is disposed at least in part, advantageously to at least a large part completely, preferably completely, within the at least one housing unit. The expression “to at least a large part completely”, is to be understood to mean in particular at least 55%, advantageously at least 65%, preferably at least 75%, particularly preferably at least 85% and particularly advantageously at least 95% completely. It is preferred that the at least one drive unit is provided so as to extend the at least one plunger, in particular at least in part, out of the at least one housing unit and/or to retract it.

The at least one drive unit is preferably configured as an electrical drive unit. It is preferred that the at least one drive unit includes at least one electric motor. It is preferred that the at least one drive unit includes at least one gear unit. The at least one gear unit is provided in particular so as to transmit the generated movement force of the electric motor to the at least one plunger.

The at least one evaluation unit is preferably provided so as to evaluate the pressure detected by at least one sensor unit, in particular by the at least one pressure sensor, in order to determine in particular the at least one position of the plunger and/or the door opening position and/or the at least one position of the refrigeration appliance door. Additionally, it is conceivable that the evaluation unit is provided so as to determine a door opening request so as to automatically open the door by the door opening apparatus as a function of the detected pressure. It is preferred that the evaluation unit includes a computing unit and, in particular in addition to the computing unit, a storage facility unit with an evaluation program stored therein for evaluating the detected pressure, in particular in accordance with the method described above, which is provided so as to be executed by the computing unit. It is preferred that the at least one sensor unit and the at least one evaluation unit are connected to one another in terms of signal technology in order to provide in particular an exchange of data.

It is preferred that the door opening apparatus includes a control unit. It is preferred that the evaluation unit is part of the control unit. It is conceivable that the evaluation unit forms the control unit at least in part, in particular completely. The term a “control unit” is to be understood in particular to mean a unit with at least one electronic control device. The at least one control unit can also be fundamentally configured as a regulating unit. The term an electronic “control device” is understood to be in particular a unit with at least one computing unit, in particular the one mentioned above, in particular a processor unit, and with at least one storage facility unit, in particular the one mentioned above, and with a control program stored in the storage facility unit. Fundamentally, the at least one control and/or regulating unit can have multiple mutually connected control devices which are preferably provided so as to communicate with one another via a bus system or via a suitable cable-connected data transmission system or via another data transmission system, such as in particular a cableless data transmission system. The at least one control unit is preferably provided so as at least to control and/or regulate the at least one electrical drive unit. It is conceivable that the at least one control unit of the door opening apparatus is integrated at least in part in a control unit of the refrigeration appliance. It is preferred that the door opening apparatus is provided so as to be connected in particular electrically to at least one electronic unit, in particular the control unit, of the refrigeration appliance.

It would be conceivable that the at least one plunger has a magnetic element at one end which faces the at least one refrigeration appliance door and contacts the at least one refrigeration appliance door of the refrigeration appliance in at least one operating state. This renders possible an advantageously good contact between the one end of the plunger and a contact surface, in particular an inner wall or a stop element, of the at least one refrigeration appliance door. The term an “inner wall of the refrigeration appliance door” is to be understood to be a wall which, in a state of the interior space closed by the refrigeration appliance door, faces the interior space of the refrigeration appliance.

It is preferred that the door opening apparatus is provided so as to be disposed at least in part within an intermediate space between the at least one body of the refrigeration appliance and at least one inner space container of the refrigeration appliance which delimits the at least one interior space. Alternatively, it is conceivable that the door opening apparatus is provided so as to be disposed within or on the at least one refrigeration appliance door. In this alternative embodiment of the door opening apparatus, the at least one plunger is preferably provided so as to push against a part of the body of the refrigeration appliance, which is facing the inner wall of the refrigeration appliance door, in order to open in particular the refrigeration appliance door.

It is preferred that the at least one pressure sensor of the at least one sensor unit is provided so as to detect an in particular absolute air pressure or a measurement variable corresponding to the air pressure within the interior space of the refrigeration appliance. The at least one pressure sensor unit is preferably configured as a barometric pressure sensor. Alternatively, however, it would also be conceivable that the at least one pressure sensor is configured as a piezo-resistive pressure sensor or as a capacitive pressure sensor or as a resonance pressure sensor or as a MEMS-based pressure sensor or as an optical pressure sensor or as a ceramic pressure sensor. It is preferred that the at least one pressure sensor is provided so as to be disposed within the interior space, in particular on a wall of the inner container which is facing the interior space. It is preferred that the sensor unit, in particular the at least one pressure sensor, is electrically connected to the at least one evaluation unit in order to determine in particular the detected pressure at the at least one evaluation unit.

It is preferred that the door opening apparatus has at least one output unit which is provided so as to transmit to a user the at least one determined position and/or at least one incorrect function of the door opening apparatus, in particular the incorrect function mentioned above and determined as a function of the detected pressure. It is preferred that the at least one output unit is provided so as to transmit to the user at least one determined position of the refrigeration appliance door and/or the at least one determined incorrect function of the door opening apparatus by an auditory signal. The at least one output unit preferably has at least one auditory output element. For example, the at least one auditory output element is configured as a loudspeaker or microphone. The at least one auditory signal is preferably configured as a warning signal and/or as a spoken message and/or music and/or sound effect. In particular, the at least one auditory signal is adapted and/or can be adapted accordingly to the respective determined position of the refrigeration appliance door and/or to the determined incorrect function of the door opening apparatus. Alternatively or additionally, it is conceivable that the at least one output unit is provided so as to transmit at least one visual signal and/or at least one haptic signal to the user. Alternatively or additionally, it is conceivable that the at least one output unit is integrated at least in part in an output unit of the refrigeration appliance, for example in a user interface of the refrigeration appliance. Alternatively or additionally, it would be conceivable that the at least one output unit is configured as a wireless communication facility for transmitting the at least one auditory signal to at least one external output unit. It would be conceivable that the at least one external unit is configured as a mobile loudspeaker and/or as a smartphone and/or as a tablet.

The term “provided” is to be understood to mean especially programmed, configured and/or equipped. The expression that an object is provided for a specific function is to be understood in particular to mean that the object fulfills and/or performs this specific function in at least one application state and/or operating state.

With the objects of the invention in view, there is concomitantly provided a refrigeration appliance with an inner container, in particular the one mentioned above, which delimits an interior space, in particular the one mentioned above, with at least the one refrigeration appliance door for closing the interior space, and with at least one door opening apparatus, in particular the one mentioned above.

The refrigeration appliance is advantageously provided so as in at least one operating state to cool goods to be stored, for example foodstuffs, such as in particular drinks, meat, fish, milk and/or milk products, or medication or vaccines or chemicals or cosmetic products or plants, in particular flowers or plant seeds, in particular in order to achieve a longer shelf life or maintain the existing quality of the goods to be stored. The refrigeration appliance can be a household refrigeration appliance, in particular a chest freezer and advantageously a refrigerator and/or an upright freezer.

It is preferred that the refrigeration appliance has at least one body. The at least one body of the refrigeration appliance preferably forms an outer housing of the refrigeration appliance. It is preferred that the at least one body and the at least one inner container are configured separately from one another. The at least one inner container is preferably accommodated in the at least one body. Alternatively, it would be conceivable that the at least one inner container and the at least one body are configured in one piece with one another. The at least one inner container preferably has at least one wall, advantageously a plurality of walls. It is preferred that the at least one interior space is delimited by the walls of the at least one inner container. The at least one inner container is, for example, made of at least a synthetic material or at least of a metal or at least of a composite material.

The term “one piece” is to be understood to mean in particular formed in one piece. It is preferred that this one piece is produced from a single blank, a mass and/or a casting, particularly preferably in an injection molding process, in particular a single-and/or multi-component injection molding process.

The interior space can be divided into multiple regions, for example a reception region and an evaporator region. It is preferred that the reception region is provided so as to receive, for example, goods to be stored, for example food stuffs, which are placed into at least one reception region by an operator. It is preferred that the refrigeration appliance has a refrigerant circuit for cooling the interior space of the refrigeration appliance. It is preferred that the refrigerant circuit includes an evaporator. It is preferred that the evaporator is disposed in the evaporator region. It is preferred that the refrigeration appliance has at least one separating element in order to spatially separate the reception region and the evaporator region.

It is preferred that the refrigeration appliance door is provided so as to counteract in particular prevent heat or cold or fluids escaping from the interior space of the refrigeration appliance or dust or foreign bodies entering the interior space, in particular in the reception region of the refrigeration appliance. It is preferred that the refrigeration appliance has at least one hinge element. In particular, the refrigeration appliance door is connected to the body by the hinge element. It is preferred that the at least one hinge element defines a fastening axis, in particular a pivot axis, so as to open and/or close the refrigeration appliance door. The refrigeration appliance door and/or the body has/have preferably at least one, in particular magnetic, sealing element. It is preferred that the sealing element of the refrigeration appliance door and/or of the body is provided so as to seal the interior space of the refrigeration appliance closed by the refrigeration appliance door with respect to a space located outside the refrigeration appliance. It is preferred that the sealing element is provided so as, in particular in a state of the refrigeration appliance closed by the refrigeration appliance door, to maintain a leakage rate below a limit value specifically set for the refrigeration appliance.

The at least one door opening apparatus is preferably disposed at least in part, in particular completely, within an intermediate space delimited by the at least one body and the inner container of the refrigeration appliance. Alternatively, it is conceivable that the at least one door opening apparatus is disposed at least in part on the at least one body, in particular the outer housing of the refrigeration appliance. Alternatively, it is likewise conceivable that the door opening apparatus is disposed at least in part, in particular completely, within the at least one refrigeration appliance door, or on the at least one refrigeration appliance door, in particular on a side of the at least one refrigeration appliance door facing the interior space of the refrigeration appliance.

It is preferred that the at least one refrigeration appliance door has at least one stop element, in particular the one mentioned above. The at least one stop element is preferably provided so as to form a stop possibility for at least one plunger, in particular the one mentioned above, of the door opening apparatus, in particular for opening the at least one refrigeration appliance door. The at least one stop element can be, for example, a pressure plate attached to the refrigeration appliance door. The pressure plate is, for example, made of at least a metal or at least of a synthetic material.

It is preferred that at least one pressure sensor, in particular the one mentioned above, of the at least one sensor unit of the at least one door opening apparatus, is disposed in particular in an assembled state of the refrigeration appliance in the at least one interior space of the refrigeration appliance. It is preferred that the at least one pressure sensor is disposed directly or indirectly on the at least one side of the at least one wall of the inner container facing the interior space. The at least one pressure sensor is advantageously disposed on an electronic unit of the refrigeration appliance. It is preferred that the electronic unit is configured as a control unit of the refrigeration appliance. It is preferred that a control unit, in particular the one mentioned above, is integrated in the at least one control unit of the refrigeration appliance so as to control the at least one door opening apparatus. It is preferred that the at least one pressure sensor is electrically connected to the electronic unit, in particular the at least one control unit of the refrigeration appliance. It is preferred that the refrigeration appliance has an output unit. In particular, the output unit is configured as a user interface of the refrigeration appliance, for example as a touch pad or as a control panel. It is preferred that the output unit has at least one output element. For example, the output element is configured as a screen, in particular a touch screen, or as a loudspeaker. It is preferred that the output unit of the refrigeration appliance is provided so as to transmit the at least one determined position of the refrigeration appliance door and/or an incorrect function of the at least one door opening apparatus to a user, for example via an auditory or visual signal.

In accordance with a further preferred embodiment, the door opening apparatus includes a door monitoring apparatus for a refrigeration appliance, in particular a refrigerator, with at least one pressure sensor for detecting a pressure within an interior space of the refrigeration appliance, and with at least one evaluation unit for analyzing the detected pressure.

It is proposed that the door monitoring apparatus includes at least one event detection unit which connects the at least one pressure sensor and the at least one evaluation unit in terms of signal technology, wherein the at least one event detection unit is provided so as, as a function of the detected pressure, to activate the at least one evaluation unit, in particular from an energy-saving mode.

Such an embodiment of the method for operating the refrigeration appliance renders it possible to provide an advantageously high level of efficiency of use, in particular an advantageously high level of energy efficiency. It is possible to provide an advantageously low average computing effort of the evaluation unit, since in particular the evaluation unit does not continuously analyze the detected pressure but only if the detected pressure fulfills predetermined conditions. Moreover, advantageously low average energy consumption is rendered possible since in particular the evaluation unit is in an energy-saving mode as long as the event detection unit has not detected a relevant pressure change.

The term a “door monitoring apparatus” is to be understood to mean in particular an apparatus for automatically monitoring at least one position of at least one at least one refrigeration appliance door of a refrigeration appliance as a function of a detected pressure. It is preferred that the door monitoring apparatus forms at least a part, in particular a sub-assembly, of the refrigeration appliance. In addition, it would be conceivable that the door monitoring apparatus is constructed as a separate module to the refrigeration appliance. It is preferred that the door monitoring apparatus can be retrofitted to a refrigeration appliance. Moreover, it is conceivable that the door monitoring apparatus is integrated at least in part, advantageously completely, in the refrigeration appliance.

It is preferred that the at least one door monitoring apparatus is provided so as to be disposed within the at least one body of the refrigeration appliance. It is conceivable that the door monitoring apparatus is integrated at least in part in a control unit of the refrigeration appliance.

It is preferred that the door monitoring apparatus is provided so as, as a function of the detected pressure, to identify opening at least one refrigeration appliance door of the refrigeration appliance, in particular by the at least one evaluation unit. The expression “opening the at least one refrigeration appliance door” is to be understood to mean in particular a process in which the at least one refrigeration appliance door is moved from a closed position, in which the at least one refrigeration appliance door closes in a sealing manner the at least one interior space of the refrigeration appliance, into an open position, for example by a user or at least one door opening unit of the refrigeration appliance in order to advantageously provide the user with access to the at least one interior space. It is preferred that the door monitoring apparatus is provided so as, as a function of the detected pressure, to identify closing the at least one refrigeration appliance door of the refrigeration appliance, in particular by the at least one evaluation unit. The expression “closing the at least one refrigeration appliance door” is to be understood to mean a process in which the at least one refrigeration appliance door is moved from the open position, in which preferably an exchange of air is provided between the at least one interior space of the refrigeration appliance and external ambient air of the refrigeration appliance, into a closed position, in which preferably the at least one refrigeration appliance door advantageously closes the at least one interior space of the refrigeration appliance in a sealing manner with respect to the external ambient air.

It is preferred that the at least one evaluation unit includes at least one computing unit. It is preferred that the at least one evaluation unit includes, in particular in addition, at least one storage facility unit. An evaluation program for analyzing the detected pressure is advantageously stored in the at least one storage facility unit.

It is preferred that the at least one computing unit is provided so as execute the evaluation program for analyzing the detected pressure. It is preferred that the at least one evaluation unit is configured as a microcontroller or microprocessor. It is conceivable that the at least one evaluation unit has at least one signal processing unit in order to convert in particular an incoming analog signal into a digital signal.

It is preferred that the at least one pressure sensor is provided so as to detect an in particular absolute air pressure or a measurement variable corresponding to the air pressure within the at least one interior space of the refrigeration appliance. It is conceivable that the at least one pressure sensor is configured as an analog pressure sensor. It is preferred that the at least one pressure sensor is configured as a digital pressure sensor. The at least one pressure sensor unit is preferably configured as a barometric pressure sensor. It is preferred that the pressure sensor is configured as an MEMS-based barometric pressure sensor. Alternatively, however, it is also conceivable that the at least one pressure sensor is configured as a piezo-resistive pressure sensor or as a capacitive pressure sensor or as a resonance pressure sensor or as an optical pressure sensor or as a ceramic pressure sensor. The at least one pressure sensor is provided so as to detect the pressure with a scanning rate of at least 15 Hz, advantageously at least 50 Hz, particularly advantageously of at least 100 Hz, preferably of at least 200 Hz, particularly preferably of at least 240 Hz. It is preferred that the at least one pressure sensor is provided so as to detect the pressure with a scanning rate of a maximum 1000 Hz, advantageously a maximum 750 Hz, particularly advantageously of a maximum 500 Hz, preferably of a maximum 300 Hz, particularly preferably of a maximum 250 Hz.

The at least one event detection unit is preferably provided so as to monitor the detected pressure. The at least one event detection unit is advantageously provided so as to compare the detected pressure with an activation pressure threshold value. The at least one event detection unit is provided so as to send an activation signal to the at least one evaluation unit if the detected pressure exceeds the activation pressure threshold value in order to wake up in particular the at least one evaluation unit from the energy saving mode. The term “energy saving mode of the at least one evaluation unit” is to be understood to mean in particular an operating state in which the energy consumption of the at least one evaluation unit is reduced to a predetermined minimum. It is preferred that, in the energy saving mode, the at least one evaluation unit has an energy consumption of preferably at least 20%, advantageously of at least 15%, particularly advantageously of at least 10%, preferably of at least 5%, particularly preferably of at least 1% with respect to a maximum energy consumption of the at least one evaluation unit. In particular, in the energy saving mode, the at least one evaluation unit has an energy consumption of preferably a maximum 70%, advantageously a maximum 60%, particularly advantageously a maximum 50%, preferably a maximum 40%, particularly preferably a maximum 30% with respect to a maximum energy consumption of the at least one evaluation unit. It is preferred that, in an operating state in which the at least one evaluation evaluates the detected pressure, the at least one evaluation unit has a greater energy consumption than in the energy saving mode.

The at least one activation pressure threshold value is preferably at least 2 Pa, advantageously at least 3 Pa, particular advantageously at least 4 Pa preferably at least 5 Pa less than or greater than a pressure reference value. It is preferred that the activation pressure threshold value is a maximum 8 Pa, advantageously a maximum 10 Pa less than or greater than the pressure reference value. The pressure reference value can be, for example, an atmospheric pressure at the installation site of the refrigeration appliance or a mean value of the detected pressure which can be determined over a period of time of at least 1 s, particular advantageously of at least 3 s, preferably of at least 5 s, particularly preferably of at least 10 s. Advantageously, the pressure reference value is a sliding mean value of the detected pressure which is in particular a mean value at least of the last five values, preferably at least of the last four values and preferably at least of the last three values of the detected pressure. It is preferred that the at least one evaluation unit and/or the at least one pressure sensor and/or the at least one event detection unit is provided so as to determine the pressure reference value. It is preferred that the at least one evaluation unit and/or the at least one pressure sensor and/or the at least one event detection unit is provided so as to determine the activation pressure threshold value.

It is conceivable that the at least one event detection unit includes at least one comparator, for example a comparator circuit, which is disposed in particular in terms of circuit technology between the at least one pressure sensor and the at least one evaluation unit. It is preferred that the comparator is provided so as to compare the detected pressure with the activation pressure threshold value and, as a function of identifying that the activation pressure threshold value is exceeded to send the activation signal to the at least one evaluation unit in order to wake up in particular the at least one evaluation unit from the energy-saving mode. Alternatively, it is conceivable that the at least one event detection unit includes an in particular energy efficient and/or current-saving microcontroller or signal processor which is provided so as to compare the detected pressure with the activation pressure threshold value and, as a function of identifying that the activation pressure threshold value is exceeded, to send the activation signal to the at least one evaluation unit in order to wake up in particular the at least one evaluation unit from the energy-saving mode.

It is preferred that the door monitoring apparatus has at least one sensor for detecting a position parameter of the at least one refrigeration appliance door. The at least one sensor for detecting the position parameter of the at least one refrigeration appliance door is preferably configured as a magneto-resistive sensor. Alternatively, it is conceivable that the at least one sensor for detecting the position parameter of the at least one refrigeration appliance door is configured as a Hall-effect sensor or as an infrared sensor or as a capacitive proximity sensor or as an inductive proximity sensor or as a rotary angle sensor or as an ultrasound sensor or as a contact switch. In particular, the at least one sensor for detecting the position parameter of the at least one refrigeration appliance door is connected to the at least one evaluation unit in terms of signal technology.

The term “provided” is to be understood to mean especially programmed, configured and/or equipped. The expression that an object is provided for a specific function is to be understood in particular to mean that the object fulfills and/or performs this specific function in at least one application state and/or operating state.

Moreover, it is proposed that the at least one event detection unit is integrated at least in part in the at least one pressure sensor. Such an embodiment renders possible an advantageously compact configuration of the door monitoring apparatus since in particular a separate external unit is not required. The at least one event detection unit is preferably integrated fully in the at least one pressure sensor. The at least one pressure sensor is preferably configured as a MEMS-based pressure sensor. It is preferred that the at least one pressure sensor includes control electronics. Advantageously, the at least one event detection unit includes the control electronics of the at least one pressure sensor. It is conceivable that the at least one event detection unit is integrated at least in part in the at least one evaluation unit. The at least one event detection unit, in particular the control electronics of the at least one pressure sensor, is preferably provided so as to compare the detected pressure with an activation pressure threshold value, in particular the one mentioned above, and, as a function of identifying that the activation pressure threshold value is exceeded, to send an activation signal, in particular the one mentioned above, to the at least one evaluation unit in order to wake up the at least one evaluation unit from the energy-saving mode.

Moreover, it is proposed that the at least one event detection unit has at least one interrupt signal line which leads from the at least one pressure sensor to the at least one evaluation unit. Such an embodiment renders it possible to provide an advantageously high level of efficiency, in particular reaction efficiency and/or energy efficiency. In particular, an interrupt signal line renders possible an advantageously at least one basically immediate reaction to a specified event. Moreover, it is advantageously possible to avoid the evaluation unit continuously querying the pressure sensor, whereby in particular an advantageously high level of computing efficiency and/or energy efficiency can be achieved. It is preferred that the at least one evaluation unit includes at least one interrupt input pin. It is preferred that the at least one pressure sensor, in particular the control electronics of the at least one pressure sensor, includes at least one interrupt output pin. It is preferred that the at least one interrupt signal line leads from the at least one pressure sensor, in particular the at least one interrupt output pin, to the at least one interrupt input pin of the at least one evaluation unit. In particular, the activation signal generated in particular by the at least one event detection unit so as to activate the at least one evaluation unit is configured as an interrupt signal. It is preferred that the at least one interrupt input pin is provided so as to receive the activation signal, in particular the interrupt signal, from the at least one event detection unit.

It is preferred that the at least one interrupt input pin is provided so as, as a function of a received interrupt signal, to trigger an interruption in order to activate in particular the evaluation of the detected pressure by the at least one evaluation unit.

It is further proposed that the door monitoring apparatus has at least one data connection line for transmitting data of the at least one pressure sensor to the at least one evaluation unit. Such an embodiment renders possible an advantageously high level and/or consistent quality of data since, in particular by a dedicated data connection line, data of the pressure sensor can be transmitted in an advantageously reliable manner and/or without a significant delay and/or without a significant distortion to the evaluation unit. Moreover, a risk of signal interference can be kept advantageously low. The data connection line is configured, for example, as an SPI-data connection line (serial peripheral interface) or as an UART-data connection line (universal asynchronous receiver-transmitter) or as a CAN-data connection line (controller area network) or as a 1-Wire-data connection line or as a Modbus-connection line or as a BLE-data connection line (Bluetooth low energy) or the like. It is preferred that the data connection line is configured as a 12C-data connection line (inter-integrated circuit). In particular, the at least one evaluation unit and the at least one pressure sensor have a corresponding communication interface.

Moreover, the invention is based on a refrigeration appliance with at least one body, with the at least one interior space disposed within the at least one body, with at least one refrigeration appliance door disposed so as to be able to move on the at least one body so as to close the at least one interior space and with the above mentioned door monitoring apparatus disposed within the at least one interior space. The refrigeration appliance is characterized in particular by the advantageous properties which can be achieved by the features described above of the door monitoring apparatus.

The refrigeration appliance is advantageously provided so as in at least one operating state to cool goods to be stored, by way of example foodstuffs, such as in particular drinks, meat, fish, milk and/or milk products, or medication or vaccines or chemicals or cosmetic products or plants, in particular flowers or plant seeds, in particular to achieve a longer shelf life or maintain the existing quality of the goods to be stored. The refrigeration appliance can be a household refrigeration appliance, in particular a chest freezer and advantageously a refrigerator and/or an upright freezer.

It is preferred that the at least one body forms an outer housing of the refrigeration appliance. It is preferred that the refrigeration appliance has at least one inner container. In particular, the at least one inner container is disposed at least in part, preferably at least to a large part, advantageously completely, within the at least one body. The expression that the at least one inner container is disposed at least to a large part completely within the at least one body is to be understood to mean that the at least one inner container is disposed at least 55%, advantageously at least 65%, particularly advantageously at least 75%, preferably at least 85%, particularly preferably at least 95%, completely within a smallest imaginary cuboid which just completely encloses the at least one body. It is preferred that the at least one body and the at least one inner container are configured separately from one another. The at least one inner container is preferably accommodated in the at least one body. Alternatively, it would be conceivable that the at least one inner container and the at least one body are configured as one piece with one another. The at least one inner container preferably has at least one wall, advantageously a plurality of walls. It is preferred that the at least one interior space is delimited by the walls of the at least one inner container. The at least one inner container is, for example, made of at least a synthetic material or at least of a metal or at least of a composite material.

The term “one piece” is to be understood to mean in particular formed in one piece. It is preferred that this one piece is produced from a single blank, a mass and/or a casting, particularly preferably in an injection molding process, in particular a single-and/or multi-component injection molding process.

The interior space can be separated into multiple regions, for example a reception region and an evaporator region. It is preferred that the reception region is provided so as to receive, for example, goods to be stored, for example food stuffs, which are placed into at least one reception region by an operator. It is preferred that the refrigeration appliance has a refrigerant circuit for cooling the interior space of the refrigeration appliance. It is preferred that the refrigerant circuit includes an evaporator. It is preferred that the evaporator is disposed in the evaporator region. It is preferred that the refrigeration appliance has at least one separating element in order to spatially separate the reception region and the evaporator region.

It is preferred that the at least one refrigeration appliance door is provided so as to counteract in particular prevent heat or cold or fluids escaping from the at least one interior space of the refrigeration appliance or dust or foreign bodies entering the at least one interior space, in particular in the reception region of the refrigeration appliance. It is preferred that the refrigeration appliance has at least one hinge element. In particular, the at least one refrigeration appliance door is connected to the at least one body by the at least one hinge element. It is preferred that the at least one hinge element defines a fastening axis, in particular a pivot axis, so as to open and/or close the at least one refrigeration appliance door. The at least one refrigeration appliance door and/or the at least one body has/have preferably at least one, in particular magnetic, sealing element. It is preferred that the at least one sealing element of the at least one refrigeration appliance door and/or of the at least one body is provided so as to seal at least one interior space of the refrigeration appliance closed by the at least one refrigeration appliance door with respect to a space located outside the refrigeration appliance. It is preferred that the at least one sealing element is provided so as, in particular in a state of the at least one interior space closed by the at least one refrigeration appliance door, to maintain a leakage rate below a limit value specifically set for the refrigeration appliance.

It is preferred that the refrigeration appliance includes further components such as for example at least one illuminating device for illuminating the interior space and/or at least one a compressor and/or at least one a fan and/or at least one container and/or at least one shelf base for storing foodstuffs or the like and/or a door opening unit for automatically opening the at least one refrigeration appliance door.

It is preferred that the refrigeration appliance includes at least one control unit, in particular the one mentioned above. The term a “control unit” is to be understood in particular to mean a unit with at least one electronic control device. The at least one control unit can also be fundamentally configured as a regulating unit. The term an electronic “control device” is to be understood in particular to mean a unit with at least one computing unit, in particular the one mentioned above, in particular a processor unit, and with at least one storage facility unit, in particular the one mentioned above, and with a control program stored in the storage facility unit. Fundamentally, the at least one control and/or regulating unit can have multiple mutually connected control devices which are preferably provided so as to communicate with one another via a bus system or via a suitable cable-connected data transmission system or via another data transmission system, such as in particular a cableless data transmission system. It is preferred that the at least one control unit is provided so as to control and/or regulate multiple components or parts of the refrigeration appliance, for example an actuation of the at least one illuminating device of the refrigeration appliance and/or an actuation of the at least one refrigerant circuit, in particular an actuation of the at least one compressor of the refrigeration appliance, and/or an actuation of the at least one fan of the refrigeration appliance and/or an actuation of the at least one door opening unit. It is preferred that the at least one control unit includes a control board.

It is preferred that the at least one door monitoring apparatus is disposed within the at least one interior space. The at least one door monitoring apparatus can be disposed in particular at least in part, advantageously completely, in the reception region or the evaporator region. It is conceivable that the at least one door monitoring apparatus is disposed on a wall of the at least one inner container facing the at least one interior space. It is preferred that the at least one door monitoring apparatus is integrated at least in part, advantageously completely, in the at least one control unit. It is preferred that the at least one door monitoring apparatus is disposed at least in part on the at least one control board of the at least one control unit.

Furthermore, the invention is based on a method for operating the door monitoring apparatus described above, wherein, in at least one detection step, in particular by the at least one pressure sensor, a pressure is detected in the interior space of the refrigeration appliance, and wherein, in the at least one analysis step, the detected pressure is evaluated in particular by the at least one evaluation unit.

It is proposed that, in at least one activation step, the at least one evaluation unit for evaluating the detected pressure is activated in particular from an energy saving mode by the at least one event detection unit as a function of the detected pressure. Such an embodiment of the method for operating the door monitoring apparatus renders it possible to provide an advantageously high level of efficiency of use, in particular an advantageously high level of energy efficiency. It is possible to provide an advantageously low average computing effort of the evaluation unit, since in particular the evaluation unit does not have to continuously analysis the detected pressure but only if the detected pressure fulfills predetermined conditions.

It is preferred that a pressure change is generated by the at least one refrigeration appliance door of the refrigeration appliance being moved, in particular by a user of the refrigeration appliance. The pressure change is advantageously generated by a pressure force exerted by the operator on the at least one refrigeration appliance door. It is preferred that, in the at least one detection step, an absolute pressure is detected in the at least one interior space of the refrigeration appliance by the at least one pressure sensor. Alternatively, it is conceivable that, in the at least one detection step, a relative pressure or a differential pressure is detected in particular relative to the atmospheric pressure at the installation site of the refrigeration device.

It is preferred that the at least one event detection unit generates in the at least one activation step as a function of the detected pressure an activation signal, in particular an interrupt signal, to the at least one evaluation unit in order in particular to wake up the evaluation unit from the energy saving mode and to initiate the at least one analysis step for analyzing the detected pressure.

It is preferred that, in at least one further detection step, at least one position parameter of the at least one refrigeration appliance door is detected in particular by at least one a further sensor of the door monitoring apparatus. It is preferred that, in at least one interior space state determination step of the method, a state of the at least one interior space opened by the at least one refrigeration appliance door and/or a state of the at least one interior space closed by the least one refrigeration appliance door is identified in particular by the at least one evaluation unit or control electronics of the at least one further sensor as a function of the detected position parameter of the at least one refrigeration appliance door. In particular, as a function of the detected position parameter of the at least one refrigeration appliance door, an open signal or a closed signal is sent to the at least one evaluation unit and/or the at least one event detection unit. For example, the at least one position parameter of the at least one refrigeration appliance door includes a detected angle between the at least one refrigeration appliance door relative to a fastening axis of the at least one refrigeration appliance door on at least one body of the refrigeration appliance and the at least one body or a detected distance of an in particular parallel edge, lying opposite the fastening axis, in particular a door frame, of the at least one refrigeration appliance door to the at least one body, or a door contact status of a contact switch or magnetic switch, or a resistor or a capacitor. It is possible, in the interior space state determination step, to identify a state of the at least one interior space opened by the at least one refrigeration appliance door if, for example, a detected angle 10° between the at least one refrigeration appliance door relative to the fastening axis of the at least one refrigeration appliance door on the at least one body and the at least one body is greater than or equal to 10° or a resistance signal detected by the at least one sensor corresponds in particular at least to 70%, advantageously at least to 80%, preferably at least to 90% of an original resistance value. In particular, it is possible, in the at least one interior space state determination step, to identify by the at least one evaluation unit a state of the at least one interior space closed by the at least one refrigeration appliance door if, for example, the detected angle is less than 10° or the resistance signal detected by the at least one sensor is less than 70%, advantageously less than 80%, preferably less than 90%, in comparison to the original resistance value.

Moreover, it is proposed that, in at least one pressure comparison step of the method, the detected pressure is compared, in particular by the at least one event detection unit, with an activation pressure threshold value, in particular the one mentioned above, wherein if, in the at least one pressure comparison step, it is identified that the detected pressure exceeds the activation pressure threshold value, the at least one activation step is initiated. It is conceivable that at least one pressure threshold value, for example the activation pressure threshold value, is stored in a storage facility of the at least one evaluation unit and/or of the at least one event detection unit. It is preferred that the at least one pressure threshold value, in particular the activation pressure threshold value, is set and/or updated as a function of a pressure reference value in at least one pressure threshold value determination step of the method, in particular by the at least one evaluation unit and/or the at least one event detection unit. It is conceivable that the at least one pressure reference value is stored in the storage facility of the at least one evaluation unit and/or of the at least one event detection unit. It is preferred that the at least one pressure reference value is set and/or updated in at least one pressure reference determination step, in particular by the at least one evaluation and/or the at least one event detection unit. It is conceivable that the at least one pressure reference determination step is performed so as to set the pressure reference value once after an initial commissioning of the refrigeration appliance at the installation site or once per day, for example every 24 hours. It is preferred that the at least one pressure reference determination step is performed at least once an hour, advantageously at least once every 10 minutes, particularly advantageously once a minute, preferably once every 30 seconds in order to update the pressure reference value. It is preferred that the pressure reference value is set in the at least one pressure reference determination step as an atmospheric pressure at the installation site of the refrigeration appliance. In particular, the atmospheric pressure at the installation site of the refrigeration appliance is only detected if, in the at least one interior space state determination step, the state of the at least one interior space opened by the at least one refrigeration appliance door is identified as a function of the detected position parameter of the at least one refrigeration appliance door. The pressure reference value is advantageously determined in the at least one pressure reference determination step by forming a mean value of the detected pressure over a period of time of at least 1 s, particular advantageously of at least 3 s, preferably of at least 5 s, particularly preferably of at least 10 s. In particular, the mean value of the detected pressure is only determined if, in the at least one interior space state determination step, the state of the at least one interior space closed by the at least one refrigeration appliance door is identified as a function of the detected position parameter of the at least one refrigeration appliance door. It is conceivable that the at least one pressure threshold value determination step is performed in order to set the at least one pressure threshold value, in particular the activation threshold value, once after an initial commissioning of the refrigeration appliance at the installation site or once per day, for example every 24 hours. It is preferred that the at least one pressure threshold value determination step is performed at least once an hour, advantageously at least once every 10 minutes, particularly advantageously once a minute, preferably at least every 30 seconds in order to update the at least one pressure threshold value, in particular the activation threshold value. It is preferred that the at least one pressure threshold value determination step is performed after each pressure reference determination step in order to determine in particular the activation threshold value as a function of pressure reference value.

Furthermore, it is proposed that, in at least one pressure reference determination step, in particular the one mentioned above, a sliding mean value of the detected pressure is formed, in particular by the at least one evaluation unit and/or the at least one event detection unit and, in at least one pressure threshold value determination step, in particular the one mentioned above, an activation pressure threshold value, in particular the one mentioned above, is determined, in particular dynamically as a function of the sliding mean value of the detected pressure formed in the at least one pressure reference determination step. Such an embodiment renders it possible to advantageously take into consideration any influence for example of a temperature change in the interior space of the refrigeration appliance when evaluating the detected pressure. It is preferred that the sliding mean value of the pressure reference value formed in the at least one pressure reference determination step is used as a pressure reference value for determining a pressure threshold value, in particular the activation threshold value. It is preferred that, in the at least one pressure reference determination step, the sliding mean value, preferably at least of the last five values, advantageously at least of the last four values and preferably at least of the last three values of the detected pressure, is formed in particular by the at least one evaluation unit and/or the at least one event detection unit. It is preferred that the at least one pressure reference determination step is only performed so as to form the sliding mean value of the detected pressure by the at least one evaluation unit and/or the event detection unit if, in the at least one interior space state determination step, a state of the interior space closed by the refrigeration appliance door is identified as a function of the detected position parameter of the refrigeration appliance. It is preferred that the at least one pressure threshold value determination step is performed after each pressure reference determination step in order in particular to determine dynamically the activation threshold value as a function of the sliding mean value of the detected pressure value.

Moreover, it is proposed that the activation pressure threshold value is set, in particular in the at least one pressure threshold value determination step, to a value which deviates from the sliding mean value of the detected pressure by a minimum 2 Pa and/or a maximum 8 Pa. Such an embodiment renders it possible to advantageously minimize a risk of the analysis step being initiated unnecessarily, whereby in particular an advantageously high level of energy efficiency and/or an advantageously high level of operating convenience can be achieved. It is preferred that, in the at least one pressure threshold value determination step, the activation pressure threshold value is set at least at 3 Pa, particularly advantageously at least at 4 Pa, preferably at least at 5 Pa greater than the pressure threshold value, in particular the sliding mean value of the detected pressure. It is preferred that the activation pressure threshold value is set in the at least one pressure threshold value determination step at a maximum of 9 Pa, advantageously at a maximum of 10 Pa, greater than the pressure reference value.

Furthermore, it is proposed that, in at least one deactivation step of the method, as a function of a pressure progression above an opening pressure threshold value that is different in particular to the activation pressure threshold value, the at least one evaluation unit is switched into the energy saving mode, in particular by the at least one evaluation unit. This renders possible an advantageously high level of efficiency, in particular energy efficiency, since in particular the evaluation unit can be switched back automatically into a state of reduced energy consumption. It is preferred that, in the at least one analysis step, in particular by the at least one evaluation unit, a pressure progression above the opening pressure threshold value is evaluated. It is preferred that a door opening request is identified as a function of the pressure progression above the opening pressure threshold value. The term a “door opening request” is to be understood to mean in particular an identified state which indicates that the at least one refrigeration appliance door of the refrigeration appliance is to be opened by at least one door opening unit of the refrigeration appliance, in particular the one mentioned above. Advantageously, the at least one evaluation unit initiates at least one door opening step so as to open the at least one refrigeration appliance door by the at least one door opening unit if a door opening request is identified in the at least one analysis step. It is conceivable that the at least one door opening step is initiated with a time delay of preferably a maximum 5 s, advantageously a maximum 4 s, particularly advantageously a maximum 3 s, preferably a maximum 2 s, particularly preferably a maximum 1 s after a door opening request has been identified in the at least one analysis step. It is preferred that a door opening request is identified in the at least one analysis step if the detected pressure exceeds the opening pressure threshold value. A door opening request is advantageously identified in the at least one analysis step if a period of time between a point in time of exceeding the opening pressure threshold value and another point in time of falling below the opening pressure threshold value by a minimum 0.1 s and/or a maximum 2 s, preferably a maximum 1.5 s, in particular a maximum 1 s, preferably a maximum 0.8 s, particularly preferably a maximum 0.6 s. The deactivation step is advantageously initiated if, in the at least one analysis step, a door opening request is not identified as a function of the pressure progression above the opening pressure threshold value. In particular, in the at least one pressure threshold value determination step, the opening pressure threshold value is set at least at 2 Pa, preferably at least at 3 Pa, advantageously at least at 4 Pa, preferably at least at 5 Pa, greater than the activation threshold value. It is preferred that the opening pressure threshold value is set in the at least one pressure threshold value determination step at a maximum of 8 Pa, advantageously at a maximum of 10 Pa, greater than the activation pressure threshold value. It is preferred that the at least one deactivation step is initiated if a door opening request is not identified in the at least one analysis step within a time period of at least 2 s, in particular of at least 3 s, advantageously of at least 4 s, preferably of at least 5 s, and a maximum 10 s after the start of the at least one analysis step, in particular after the point in time of exceeding the activation pressure threshold value.

Furthermore, it is proposed that, in the at least one further deactivation step, the at least one evaluation unit is switched into the energy saving mode if, in the at least one analysis step, a state of the at least one interior space of the refrigeration appliance closed by at least one refrigeration appliance door is identified, in particular after opening the at least one refrigeration appliance door by a user and/or the at least one door opening unit. This renders possible an advantageously high level of energy efficiency, since in particular the evaluation unit is switched back into a state of reduced energy consumption after a completed evaluation of the pressure. It is preferred that the state of the at least one interior space of the refrigeration appliance closed by the at least one refrigeration appliance door is identified as a function of the detected pressure in the at least one analysis step. In particular, in the at least one analysis step, opening the at least one refrigeration appliance door is identified as a function of the detected pressure. In particular, in the at least one analysis step, closing the at least one refrigeration appliance door is identified as a function of the detected pressure. The state of the at least one interior space of the refrigeration appliance closed by the at least one refrigeration appliance door is advantageously identified in the at least one analysis step as a function of the detected pressure if, after opening the at least one refrigeration appliance door is identified, closing the at least one refrigeration appliance door is identified. Alternatively or additionally, it is conceivable that the state of the at least one interior space of the refrigeration appliance closed by the at least one refrigeration appliance door is identified as a function of the detected position parameter of the at least one refrigeration appliance door. In particular, the state of the at least one interior space of the refrigeration appliance closed by the at least one refrigeration appliance door is identified as a function of the detected position parameter of the at least one refrigeration appliance door if the closed signal follows the open signal sent by the at least one further sensor. The at least one evaluation unit checks in the at least one analysis step whether the detected position parameter of the refrigeration appliance door correlates with the detected pressure in order to confirm an evaluation of the detected pressure, in particular in order to confirm the state of the at least one interior space of the refrigeration appliance closed by the at least one refrigeration appliance door. It is conceivable that the at least one further deactivation step is initiated with a time delay of at least 2 s, in particular of at least 3 s, advantageously of at least 4 s, preferably of at least 5 s, and a maximum 10 s after the identification of the state of the at least one interior space closed by the at least one refrigeration appliance door.

The method in accordance with the invention for operating the door opening apparatus in accordance with the invention, the door opening apparatus in accordance with the invention and the refrigeration appliance in accordance with the invention are not to be limited hereby to the above-described application and embodiment. In particular, so as to fulfill the function described herein, the method in accordance with the invention for operating the door opening apparatus in accordance with the invention, the door opening apparatus in accordance with the invention and the refrigeration appliance in accordance with the invention can have a number of individual elements, components, units, and/or method steps that differs from a number specified herein.

Other features which are considered as characteristic for the invention are set forth in the appended claims.

Although the invention is illustrated and described herein as embodied in a method for operating a door opening apparatus, a door opening apparatus and a refrigeration appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Further advantages are evident from the description below of the drawing. Exemplary embodiments of the invention are illustrated in the drawing. The drawing, the description and the claims contain numerous features in combination. The person skilled in the art will also consider the features individually in an expedient manner and combine them to form expedient further combinations.

### BRIEF DESCRIPTION OF THE FIGURES

FIG. 1 is a schematic flow diagram of a method in accordance with the invention for operating a door opening apparatus in accordance with the invention for a refrigeration appliance in accordance with the invention;

FIG. 2 is an exemplary graph of a detected pressure progression during the course of the method in accordance with the invention;

FIG. 3 is a diagrammatic, perspective view of the refrigeration appliance in accordance with the invention with the door opening apparatus in accordance with the invention;

FIG. 4 is an enlarged, fragmentary, sectional view of the refrigeration appliance in accordance with the invention with the door opening apparatus in accordance with the invention;

FIG. 5 is a schematic flow diagram of an alternative exemplary embodiment of the method in accordance with the invention for operating the door opening apparatus in accordance with the invention for the refrigeration appliance in accordance with the invention;

FIG. 6 is a schematic flow diagram of a further alternative exemplary embodiment of the method in accordance with the invention for operating the door opening apparatus in accordance with the invention for the refrigeration appliance in accordance with the invention;

FIG. 7 is a front-elevational view of a refrigeration appliance in accordance with the invention with a door monitoring apparatus in accordance with the invention;

FIG. 8 is a circuit diagram of the door monitoring apparatus in accordance with the invention;

FIG. 9 is a schematic flow diagram of a method in accordance with the invention for operating a door monitoring apparatus in accordance with the invention; and

FIG. 10 is an exemplary pressure-time diagram of a detected pressure progression during the course of the method in accordance with the invention.

### DETAILED DESCRIPTION OF THE INVENTION

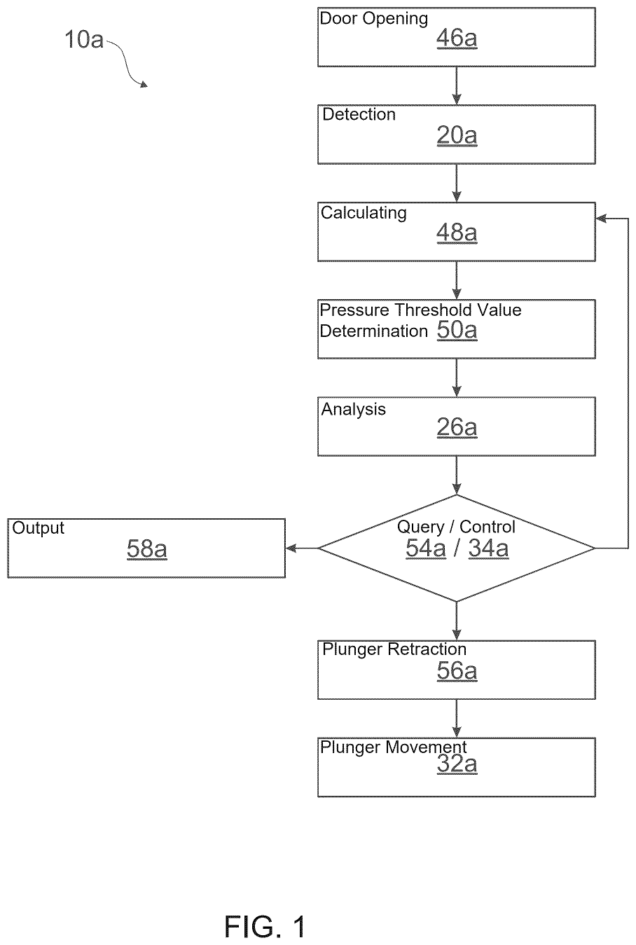

Referring now to the figures of the drawings in detail and first, particularly, to FIG. 1 thereof, there is seen a schematic flow diagram of a method 10a for operating a door opening apparatus 12a for a refrigeration appliance 14a configured in the present case as a refrigerator.

The method 10a has at least one door opening step 46a. In the at least one door opening step 46a of the method 10a, at least one refrigeration appliance door 18a of the refrigeration appliance 14a is opened by at least one plunger 16a of the door opening apparatus 12a from a closed position of the at least one refrigeration appliance door 18a. In the at least one door opening step 46a, the at least one plunger 16a is moved from a retracted position of the at least one plunger 16a toward the at least one refrigeration appliance door 18a in order to open in particular the at least one refrigeration appliance door 18a. In the at least one door opening step 46a, the at least one plunger 16a is driven by at least one drive unit 40a of the door opening apparatus 12a. The at least one door opening step 46a is initiated in particular by an operator input, for example by an actuating element (not illustrated) or by a pressure change generated by the operator at least in one interior space 24a of the refrigeration appliance 14a. In particular, the operator input is evaluated by the at least one evaluation unit 42a of the door opening apparatus 12a and a control signal is transmitted to the at least one drive unit 32a so as to perform the at least one door opening step 46a.

The method 10a has at least one detection step 20a for detecting a pressure within the refrigeration appliance 14a, in particular within the at least one interior space 24a, by at least one sensor unit 22a of the door opening apparatus 12a. In the at least one detection step 20a of the method 10a, the pressure is detected in the present case with a scanning rate of 20 Hz. In the at least one detection step 20a, an absolute pressure is detected in the interior space 24a of the refrigeration appliance 14a. Alternatively, it is conceivable that a relative pressure or a differential pressure, in particular relative to an atmospheric pressure at the installation site of the refrigeration device 14a, is detected in the at least one detection step 20a.

In at least one calculating step 48a of the method 10a, a sliding mean value of the detected pressure is formed by the at least one evaluation unit 42a of the door opening apparatus 12a in order to determine at least one pressure threshold value for determining a position of the at least one plunger of the door opening apparatus. In the calculating step 48a, a sliding mean value of the last three values of the detected pressure is formed in the present case. The sliding mean value of the detected pressure formed in the at least one calculating step 48a is used as a pressure reference value for determining the at least one pressure threshold value in at least one pressure threshold value determination step 50a of the method 10a. In the present case, the pressure threshold value determination step 50a is performed after each calculating step 48a in order to dynamically determine in particular the at least one pressure threshold value as a function of the sliding mean value of the detected pressure. In the at least one pressure threshold value determination step 50a of the method 10a, at least one predetermined constant value is added to or subtracted from the sliding mean value in order to determine the at least one pressure threshold value. Alternatively, in the at least one pressure threshold value determination step 50a, a percentage value of the sliding mean value is determined and added to the sliding mean value or subtracted from the sliding mean value in order to determine the at least one pressure threshold value. Alternatively, in the at least one pressure threshold value determination step 50a, a predetermined factor is multiplied or divided by the sliding mean value in order to determine the at least one pressure threshold value.

The method 10a has at least one analysis step 26a in which the at least one position of the at least one plunger 16a of the door opening apparatus 12a is determined as a function of the detected pressure. Through the use of the at least one door opening step 46a, in particular by the effect of force of the at least one plunger 16a on the at least one refrigeration appliance door 18a, a pressure change is generated in the interior space 24a, wherein the pressure change in the interior space 24a is evaluated in the at least one analysis step 22a.

In the at least one analysis step 26a of the method 10a, a prevailing position of the at least one plunger 16a of the door opening apparatus 12a at the at least one refrigeration appliance door 18a of the refrigeration appliance 14a is determined as a function of the detected pressure. In the at least one analysis step 26a, a prevailing position of the at least one plunger 16a is determined if, advantageously after initiating the at least one door opening step 46a so as to open the refrigeration appliance door 18a, the detected pressure falls below a plunger position threshold value 30a determined by the at least one pressure threshold value determination step 50a. In the at least one pressure threshold determination step 50a, the plunger position threshold value 30a is set in the present case at 0.2 Pa less than the pressure reference value, in particular the sliding mean value of the detected pressure.

In the at least one analysis step 26a of the method 10a, opening the at least one refrigeration appliance door 18a is identified by the at least one evaluation unit 42a as a function of the detected pressure. In the at least one analysis step 26a, the opening of the at least one refrigeration appliance door 18a is determined as a function of a negative pressure change, in particular as a function of a negative pressure. The opening of the at least one refrigeration appliance door 18a is identified in the at least one analysis step 26a if the pressure falls below an opening threshold value 28a, in particular crosses within an opening time interval of a maximum 0.5 s. The at least one opening threshold value 28a is set in the pressure threshold value determination step 50a at 0.5 Pa less than the pressure reference value, in particular the sliding mean value of the detected pressure.

In the at least one analysis step 26a of the method 10a, closing the at least one refrigeration appliance door 18a is identified by the at least one evaluation unit 42a as a function of the detected pressure. In the at least one analysis step 26a, the closing of the at least one refrigeration appliance door 18a is determined as a function of a positive pressure change, in particular as a function of an overpressure. The closing of at least one refrigeration appliance door 18a, is identified in the at least one analysis step 26a if the pressure exceeds a closing threshold value, in particular crosses within a closing time interval of a maximum 0.5 s. In particular, in the at least one pressure threshold value determination step 50a the closing threshold value is set at least at 0.5 greater than the opening threshold value 28a.

In the at least one analysis step 26a of the method 10a, a door opening position of the at least one plunger is determined, in particular by the at least one evaluation unit 42a, as a function of the detected pressure. In the at least one analysis step 26a, the door opening position of the at least one plunger 16a is determined as a function of falling below, in particular crossing, the opening threshold value 28a. In the present case, the door opening position is determined by the at least one evaluation unit 42a if opening the refrigeration appliance door is identified in the at least one analysis step 26a. Moreover, in the at least one analysis step 26a, the door opening position of the at least one plunger is determined as a function of a time period between falling below the pressure threshold value 30a and a subsequent minimum of the detected pressure. The evaluation unit 42a detects points in time between initiating the door opening step 46a and falling below the plunger position threshold value 30a and a subsequently identified minimum of the detected pressure and determines the door opening position by using the detected points in time and a movement speed of the at least one plunger 16a.

The door opening position of the at least one plunger 16a is determined in the at least one analysis step 26a in such a manner that a spacing between an end of the at least one plunger 16a facing the at least one refrigeration appliance door 18a and a contact surface of the at least one refrigeration appliance door 18a is less than a limit value, advantageously is a maximum 7 mm, but the at least one plunger 16a does not contact the at least one refrigeration appliance door 18a, in particular the stop surface of the at least one refrigeration appliance door 18a. The stop surface of the at least one refrigeration appliance door 18a is, for example, an inner wall of the at least one refrigeration appliance door 18a or a stop element 76a of the at least one refrigeration appliance door 18a.

The method 10a has at least one query step 54a. In the at least one query step 54a of the method 10a, the at least one evaluation unit 42a checks whether a specific instruction is present for a result of the at least one analysis step 22a. If a specific instruction is not present, the at least one detection step 20a, the at least one calculating step 48a, the at least one pressure threshold value determination step 50a and the at least one analysis step 26a are repeated. If a specific instruction for the result of the at least one analysis step 26a is present, the at least one evaluation unit 42a executes this instruction. At least one specific instruction is stored in a storage facility of a storage facility unit of the at least one evaluation unit 42a at least for the result of an identified opening of the at least one refrigeration appliance door 18a and/or the result of determining the door opening position of the at least one plunger 16a. If opening the at least one refrigeration appliance door 18a is identified in the at least one analysis step 26a, the at least one specific instruction causes the at least one evaluation unit 42a, for example, to determine the door opening position of the plunger 16a as a function of the detected pressure. If a door opening position of the plunger 16a is determined in the at least one analysis step 26a, the at least one specific instruction causes the at least one evaluation unit 42a, for example, to update a start position of the plunger 16a in the door opening step 46a or to update an end position of the plunger 16a in a plunger retraction step 56a of the method 10a. Moreover, if, for example, opening and/or closing the at least one refrigeration appliance door 18a is identified in the at least one analysis step 26a, the at least one specific instruction causes the at least one evaluation unit 42a, for example, to trigger at least one output step 58a of the method 10a. For example, in the at least one output step 58a, the at least one determined position of the at least one refrigeration appliance door 18a is transmitted to a user in particular by at least one output unit (not illustrated) of the refrigeration appliance 14a, for example by a user interface of the refrigeration appliance 14a. It would be conceivable that in the at least one output step 58a, the at least one position of the refrigeration appliance door 18a is transmitted by an auditory and/or visual and/or haptic signal to the user.

The evaluation unit 42a determines in the at least one method step a completely extended state of the at least one plunger 16a, for example, using a voltage measurement at the drive unit 40a. If, in the at least one query step 54a, this specific event is identified, the evaluation unit 42a triggers within the method 10a the at least one plunger retraction step 56a of the method 10a. It is conceivable that the plunger remains at the completely extended position for, for example, 1, 2, 3, 4 or 5 seconds before the plunger retraction step 56a is initiated. In the at least one plunger retraction step 56a, the at least one plunger 16a is moved from the extended position to the retracted position in order to enable closing the at least one refrigeration appliance door 18a by an operator and/or a reset element (not illustrated) of the refrigeration appliance 14a, in particular without the at least one refrigeration appliance door 18a striking the at least one plunger 16a.

The method 10a has at least one plunger movement step 32a. In the at least one plunger movement step 32a of the method 10a, the at least one plunger 16a of the door opening apparatus 12a is moved to the determined door opening position by the at least one drive unit 40a of the door opening apparatus 12a. The at least one plunger movement step 32a is initiated in terms of time after the at least one plunger retraction step 56a, in particular after completion of the at least one plunger retraction step 56a. In particular, the at least one plunger 16a is moved in the at least one plunger movement step 32a from the completely retracted position of the at least one plunger 16a to the door opening position. However, it would also be conceivable that the plunger movement step 32a is initiated directly after completion of the at least one the door opening step 46a in order in particular to move the at least one plunger 16a out of a completely extended position to the determined door opening position. The plunger movement step 32a could replace the plunger retraction step 56a of the method 10a. The determined door opening position is set as a new start position of the at least one plunger 16a in the case of a renewed performance of the at least one door opening step 46a. The determined door opening position is set as a new end position of the at least one plunger 16a in the case of a renewed performance of the at least one plunger retraction step 56a. The at least one plunger 16a remains in the door opening position after a performance of at least one plunger retraction step 56a until the next performance of the at least one door opening step 46a.

The method 10a has at least one control step 34a. In the at least one control step 34a of the method 10a, at least one functional capability of the door opening apparatus 12a, in particular opening the at least one refrigeration appliance door 18a by the at least one plunger 16a is monitored as a function of the detected pressure, by the at least one evaluation unit 48a. The at least one control step 34a is part of the query step 54a. In the at least one control step 34a, a pressure change in the at least one interior space 24a of the refrigeration appliance 14a which must have been generated by opening the at least one refrigeration appliance door 18a is monitored, in particular by the at least one plunger 16a. In the at least one control step 34a it is monitored as to whether, when initiating the at least one door opening step 46a, opening the at least one refrigeration appliance door 18a is identified. In the at least one control step 34a, an incorrect function of the door opening apparatus 12a is identified as a function of the detected pressure. If opening the at least one refrigeration appliance door 18a is not identified after a predetermined time, for example 5 s, an incorrect function of the door opening apparatus 12a is determined by the at least one evaluation unit 42a. In the event of an identified incorrect function of the door opening apparatus 12a, a control signal is transmitted in the at least one control step 34a from the at least one evaluation unit 42a, for example to the output unit (not illustrated) of the refrigeration appliance 14a, so as to output a warning signal by the output unit to a user. The warning signal is configured, for example, as a warning sound or as a message.

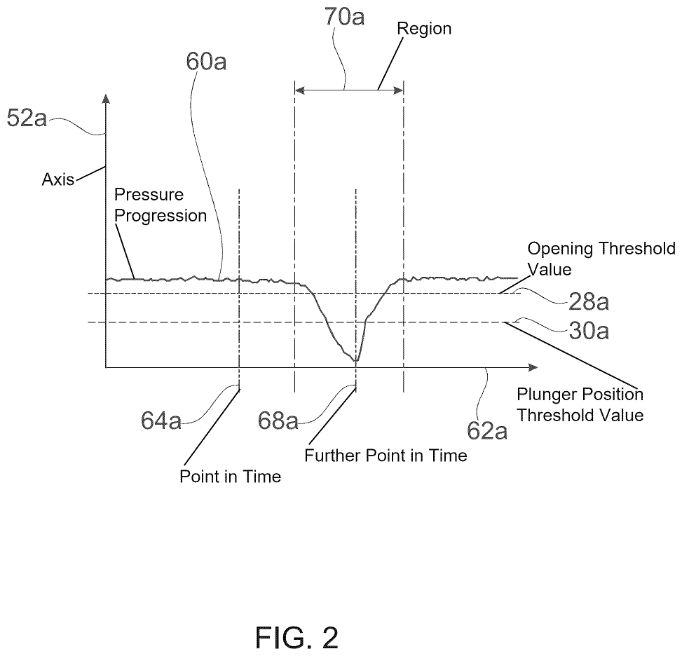

FIG. 2 shows a time-pressure diagram for describing an exemplary pressure progression 60a during the course of the method 10a. The pressure progression 60a describes an absolute pressure in the interior space 24a of the refrigeration appliance 14a detected by at least one sensor unit 22a in the at least one detection step 20a as a function of a time. The detected absolute pressure is plotted on an axis 52a over an axis 62a of time.

The pressure progression 60a starts with at least one basically constant pressure which corresponds to the atmospheric pressure at the installation site of the refrigeration appliance 14a. The interior space 24a is in a state closed by the refrigeration appliance door 18a. In the at least one calculating step 48a of the method 10a, a sliding mean value of the detected pressure is determined, in particular dynamically. At a point in time 64a, the at least one door opening step 46a of the method 10a is initiated by a user so as to open the refrigeration appliance door 18a.

The at least one plunger 18a is moved in the at least one door opening step 46a by the drive unit 40a toward the refrigeration appliance door 18a. In particular, a pushing force is exerted on the refrigeration appliance door 18a by the plunger 16a in order to open the refrigeration appliance door 18a. In particular, by a sealing element 66a of the refrigeration appliance 14a, preferably before the sealing element 66a detaches from the refrigeration appliance door 18a, a volume of the interior space 24a increases by the sealing element 66a expanding, whereby pressure is reduced in the interior space 24a. At a further point in time 68a, the sealing element 66a detaches from the refrigeration appliance door, whereby ambient air flows into the interior space 24a. The detected pressure increases until the atmospheric pressure is achieved again at the installation site of the refrigeration appliance 14a.

In a region 70a of the pressure progression 60a, a pressure change, in particular a negative pressure, is detected by the at least one sensor unit 22a. In the region 70a, the detected pressure of the pressure progression 60a falls below the plunger position threshold value 30a which is determined as a function of sliding mean value of the detected pressure in the at least one pressure threshold value determination step 50a of the method 10a by the at least one evaluation unit 42a. In the at least one pressure threshold value determination step 50a, the plunger position threshold value 30a is set at 0.2 Pa less than the sliding mean value of the detected pressure. As a result, a prevailing position of the plunger 16a at the refrigeration appliance door 18a is identified in the at least one analysis step 26a.

Moreover, the detected pressure falls below an opening threshold value 28a in the region 70a. In the at least one pressure threshold value determination step 50a, the opening threshold value 28a is set at 0.5 Pa less than the sliding mean value of the detected pressure. In particular, the detected pressure crosses the opening threshold value 28a in the region 70a within an opening time interval of a maximum 0.5 s. As a result, in the at least one analysis step 26a of the method 10a, the at least one evaluation unit 42a identifies opening the refrigeration appliance door 18a for the region 70a of the pressure progression 60a.

In the query step 54a of the method 10a, the determination of the door opening position in the analysis step 26a is triggered by the identification of the opening of the refrigeration appliance door 18a. The at least one evaluation unit 42a determines the door opening position in the at least one analysis step 26a by the point in time of initiating the door opening step, in particular the point in time 64a of falling below the plunger position threshold value and an additional point in time of achieving the minimum of the detected pressure, in particular a further point in time 68a, and the movement speed of the at least one plunger 16a.

The at least one plunger 16a is moved after completion of the at least one door opening step 46a by the at least one plunger retraction step 56a of the method 10a to the completely retracted position of the at least one plunger 16a. The at least one plunger movement step 32a is initiated in terms of time after the at least one plunger retraction step 56a, in particular by the at least one evaluation unit 42a. In particular, the at least one plunger 16a is moved in the at least one plunger movement step 32a from the completely retracted position of the at least one plunger 16a to the door opening position, in particular by the at least one drive unit 40a.

Alternatively, it is conceivable that the plunger movement step 32a is initiated after completion of the door opening step 46a, in particular by the at least one evaluation unit 42a in order in particular to move the plunger 16a out of a completely extended position to the determined door opening position. In particular, the determined door opening position is set as a new start position of the at least one plunger 16a in the case of a renewed performance of the at least one door opening step 46a. In particular, the determined door opening position is set as a new end position of the plunger in the case of a renewed performance of the at least one plunger retraction step 56a. It is preferred that the at least one plunger remains in the door opening position after a performance of at least one plunger retraction step 56a until the next performance of the at least one door opening step 46a.

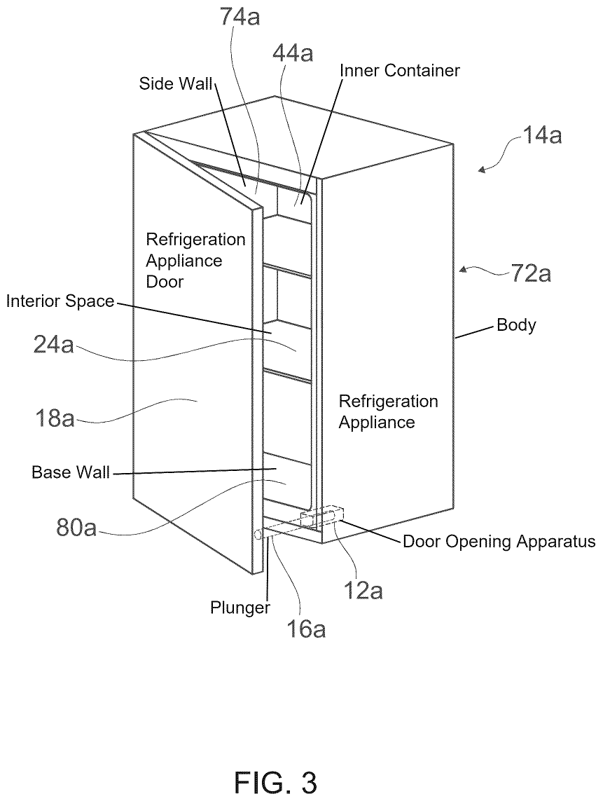

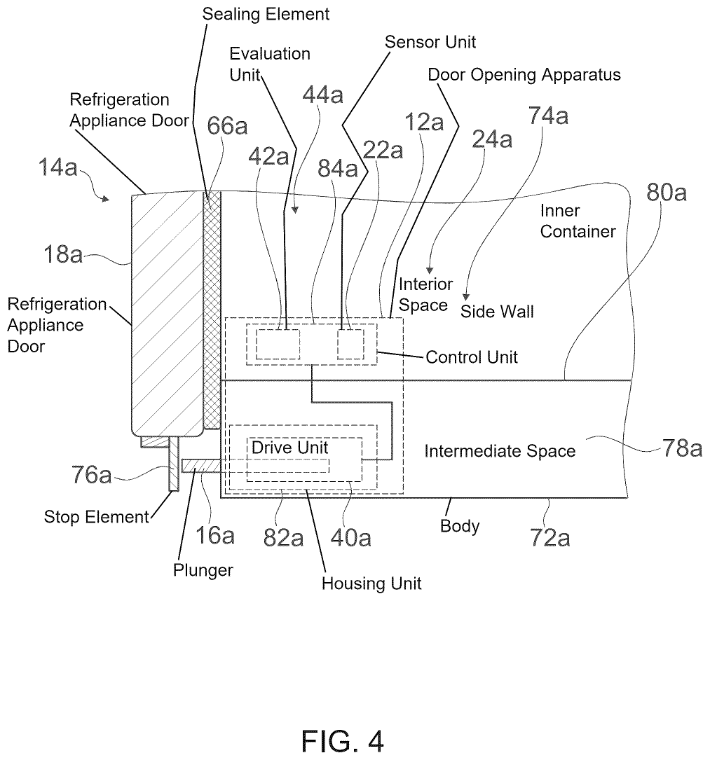

FIGS. 3 and 4 show a schematic representation of the refrigeration appliance 14a configured as a refrigerator. The refrigeration appliance 14a has at least one body 72a. The at least one body 72a of the refrigeration appliance 14a forms an outer housing of the refrigeration appliance 14a.

The refrigeration appliance 14a has at least one inner container 44a. In the present case, the at least one body 72a and the at least one inner container 44a are configured separately from one another. Alternatively, however, it would also be conceivable that the at least one body 72a and the at least one inner container 44a are configured as one piece with one another. The at least one inner container 44a is accommodated in the at least one body 72a. The inner container 44a of the refrigeration appliance 14a can be configured, for example, as a refrigeration compartment or a freezer compartment. The at least one inner container 44a is, for example, made of at least a synthetic material or at least a metal. The at least one inner container 44a has a plurality of walls, in particular a side wall 74a, a further side wall, a base wall 80a, a ceiling wall and a rear wall.

The refrigeration appliance 14a has the interior space 24a disposed within the at least one body 72a. The at least one interior space 24a is delimited by the walls of the at least one inner container 44a of the refrigeration appliance 14a.

The refrigeration appliance 14a has the at least one refrigeration appliance door 18a disposed in a movable manner on the at least one body 72a so as to close the interior space 24a. The at least one refrigeration appliance door 18a of the refrigeration appliance 14a is pivotably connected to the at least one body 40a, in particular by at least one hinge element (not illustrated). The at least one refrigeration appliance door 18a and/or the at least one body 40a has/have, for example, at least one sealing element 66a. The at least one sealing element 66a is provided so as to seal the at least one interior space 24a of the refrigeration appliance 14a closed by the at least one refrigeration appliance door 18a with respect to a space located outside the refrigeration appliance 14a. The at least one sealing element 66a is provided so as, in particular in a state of the refrigeration appliance 14a, in particular of the interior space 24a, closed by the refrigeration appliance door 18a, to maintain a leakage rate below a limit value specifically set for the refrigeration appliance 14a configured as a refrigerator in order to fulfill, for example, the standard according to ISO 15502 or EN 62552. The at least one refrigeration appliance door 18a is configured in the present case as a door. Alternatively, it would be conceivable that the at least one refrigeration appliance door 18a is configured as a flap or window or as a unit appearing to a person skilled in the art as further expedient for closing an interior space of a refrigeration appliance. In the present case, the at least one refrigeration appliance door 18a has at least one inner wall and at least one outer wall. The at least one inner wall and the at least one outer wall of the at least one refrigeration appliance door 18a form an intermediate space in which a thermally insulating material, for example a thermally insulating foam is inserted. The at least one refrigeration appliance door 18a has at least one stop element 76a. The stop element 76a is provided so as to form a stop possibility or a contact surface for the at least one plunger 16a of the door opening apparatus 12a, in particular so as to open the at least one refrigeration appliance door 18a. The stop element 76a is a pressure plate attached to the at least one refrigeration appliance door 18a. The pressure plate is made of a metal in the present case.

The refrigeration appliance 14a has the at least one door opening apparatus 12a disposed within the at least one body 72a. The at least one door opening apparatus 12a is disposed at least in part within an intermediate space 78a between the at least one body 72a of the refrigeration appliance 14a and the at least one inner container 44a, in particular the base wall 80a of the at least one inner container 44a of the refrigeration appliance 14a. Alternatively, it would also be conceivable that the at least one door opening apparatus 12a is disposed at least in part on the at least one body 72a, in particular the outer housing of the refrigeration appliance 14a. Alternatively, however, it would also be conceivable that the at least one door opening apparatus 12a is disposed within, in particular in the intermediate space between the at least one inner wall and the at least one outer wall of the at least one refrigeration appliance door 18a or on the at least one refrigeration appliance door 18a, in particular on the at least one inner wall of the at least one refrigeration appliance door 18a.

A thermally insulating material, for example a thermally insulating foam, is inserted into the intermediate space 78a between the at least one body 72a of the refrigeration appliance 14a and the at least one inner container 44a.

The at least one door opening apparatus 12a has at least one housing unit 82a. The at least one door opening apparatus 12a has the at least one drive unit 40a. The at least one drive unit 40a is disposed, in particular completely, within the at least one housing unit 82a. The at least one door opening apparatus 12a has the at least one plunger 16 which can be driven by the at least one drive unit 40a. The at least one plunger 16a is disposed, at least in part, within the at least one housing unit 82a. It would be conceivable that the at least one plunger 16a is disposed in a completely retracted state completely within the housing unit 82a. The at least one drive unit 40a is provided so as to retract the at least one plunger 16a, in particular at least in part, out of the at least one housing unit 82a and/or extend it.

The at least one drive unit 40a is preferably configured as an electrical drive unit. The at least one drive unit 40a has at least one electric motor (not illustrated). The at least one drive unit 40a has at least one gear unit (not illustrated). The at least one gear unit of the at least one drive unit 40a is provided so as to transmit the generated movement force of the electric motor to the at least one plunger 16a.

The at least one door opening apparatus 12a has the at least one sensor unit 22a for detecting the pressure within the interior space 24a of the refrigeration appliance 14a which can be closed by the at least one refrigeration appliance door 18a of the refrigeration appliance 14a. The at least one sensor unit 22a has at least one pressure sensor (not illustrated). The at least one pressure sensor of the at least one sensor unit 22a is provided so as to detect an in particular absolute air pressure within the interior space 24a of the refrigeration appliance 14a. The at least one pressure sensor is configured in the present case as a barometric pressure sensor for detecting an absolute pressure.

The at least one door opening apparatus 12a has the at least one evaluation unit 42a. The at least one evaluation unit 42a is configured, for example, as a microcontroller. The at least one evaluation unit 42a of the door opening apparatus 14a is integrated in the present case at least in part in a control unit 84a of the refrigeration appliance 14a. The at least one evaluation unit 42a is provided so as to evaluate the pressure detected by the at least one sensor unit 22a. The at least one evaluation unit 42a is provided so as, as a function of the pressure detected in particular by the sensor unit 22a, to determine the at least one position of the at least one plunger 16a of the door opening apparatus 12a and/or the at least one position of the at least one refrigeration appliance door 18a of refrigeration appliance 14a and/or the door opening position of the at least one plunger 16a.

The at least one sensor unit 22a, in particular the at least one pressure sensor, is disposed on the control unit 84a of the refrigeration appliance 14a. In particular, the control unit 84a of the refrigeration appliance 14a has a control board. Advantageously, the at least one sensor unit 22a and the at least one evaluation unit 42a are disposed on the control board of the control unit 84a of the refrigeration appliance 14a. The control unit 84a of the refrigeration appliance 14a is disposed on a wall facing the at least one interior space 24a, in the present case on the side wall 74a, of the at least one inner container 44a of the refrigeration appliance 14a.

The at least one door opening apparatus 12a has at least one output unit (not illustrated) which is provided so as to transmit to a user at least one determined position and/or the at least one incorrect function of the door opening apparatus 12a determined as a function of the detected pressure. In the present case, the at least one output unit of the door opening apparatus 12a is integrated in an output unit of the refrigeration appliance 14a. In the present case, the output unit is configured as a user interface, for example as a control touch screen, of the refrigeration appliance 14a. The at least one output unit is provided so as to transmit to the user the at least one determined position of the refrigeration appliance door 18a and/or the at least one determined incorrect function of the door opening apparatus 12a by an auditory and/or visual and/or haptic signal. The output unit has, for example, an auditory and/or a visual and/or a haptic output element, for example a loudspeaker and/or a touchscreen. The auditory and/or visual and/or haptic signal is configured, for example, as a message, in particular a spoken or written message or as a warning tone. Alternatively or additionally, it would be conceivable that the at least one output unit is configured as a wireless communication facility for transmitting the at least one auditory signal and/or visual and/or haptic signal to at least one external output unit. It would be conceivable that the at least one external unit is configured as a mobile loudspeaker and/or as a smartphone and/or as a tablet and/or as a smart watch.

In the figures, in each case only one of the multiple provided objects is provided with a reference character.

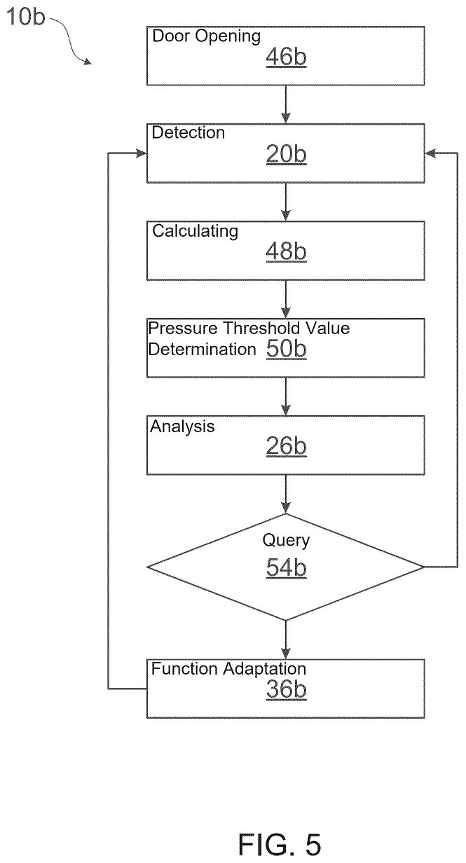

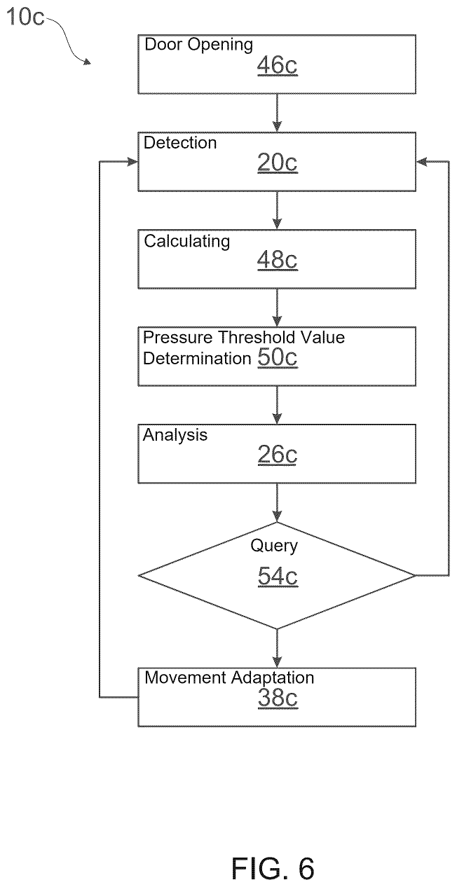

Two further exemplary embodiments of the invention are illustrated in FIGS. 5 and 6. The descriptions below are basically limited to the differences between the exemplary embodiments, wherein reference can be made to the description of the exemplary embodiment in FIGS. 1 to 4 with regard to identical components, features, and functions. In order to distinguish between the exemplary embodiments, the letter a in the reference characters of the exemplary embodiment in FIGS. 1 to 4 is replaced by the letter b in the reference characters of the exemplary embodiment in FIG. 5 and by the letter c in the reference character of the exemplary embodiment in FIG. 6. With regard to components with the same designation, in particular with regard to components with the same reference characters, reference can fundamentally also be made to the drawings and/or the description of the exemplary embodiment in FIGS. 1 to 4.

FIG. 5 illustrates a schematic flow diagram of a method 10b for operating a door opening apparatus for a refrigeration appliance, in particular a refrigerator. The method 10b has at least one detection step 20b for detecting a pressure within the refrigeration appliance, in particular within the at least one interior space of the refrigeration appliance, through the use of the at least one sensor unit of the door opening apparatus. In at least one door opening step 46b of the method 10b, at least one refrigeration appliance door of the refrigeration appliance is opened by at least one plunger of the door opening apparatus. In at least one calculating step 48b of the method 10b, a sliding mean value of the detected pressure is formed by at least one evaluation unit of the door opening apparatus in order to determine at least one pressure threshold value for determining a position of at least one plunger of the door opening apparatus. The sliding mean value of the detected pressure formed in the at least one calculating step 48b is used as a pressure reference value for determining the at least one pressure threshold value in at least one pressure threshold value determination step 50b of the method 10b. In the present case, the pressure threshold value determination step 50b is performed after each calculating step 48b in order to dynamically determine in particular the at least one pressure threshold value as a function of the sliding mean value of the detected pressure. The method 10b has at least one analysis step 26b in which, as a function of the detected pressure, the at least one position of the at least one plunger 16b of the door opening apparatus is determined by the evaluation unit. Moreover, in the at least one analysis step 26b, opening and/or closing the refrigeration appliance door is determined by the at least one evaluation unit as a function of the detected pressure. The method 10b has at least one query step 54b. In the at least one query step 54b of the method 10b, the at least one evaluation unit checks whether a specific instruction is present for a result of the at least one analysis step 26b. If a specific instruction is not present, the at least one detection step 20b, the at least one calculating step 48b, the at least one pressure threshold value determination step 50b and the at least one analysis step 26b are repeated. If a specific instruction for the result of the at least one analysis step 26b is present, the at least one evaluation unit executes it. At least one specific instruction is stored in a storage facility of a storage facility unit of the at least one evaluation at least for the result of an identified opening of the at least one refrigeration appliance door and/or for the result of an identified closing of the at least one refrigeration appliance door and/or for the result of an identified contact of the at least one plunger with the at least one refrigeration appliance door. If, for example, opening the refrigeration appliance door or a contact of the at least one plunger with the at least one refrigeration appliance door is identified, the at least one specific instruction causes the at least one evaluation unit, for example, to trigger at least one function adaptation step 36b of the method 10b for regulating at least one function of the refrigeration appliance. In the at least one function adaptation step 36b, as a function of the position of the at least one plunger determined by the at least one evaluation unit and/or the position of the at least one refrigeration appliance door, a function of the refrigeration appliance is regulated by the at least one evaluation unit.

In the at least one function adaptation step 36b of the method 10b, a power of the refrigeration appliance, in particular a component of the refrigeration appliance, for example a compressor or a fan, is regulated as a function of the determined position of the at least one plunger and/or the position of the at least one refrigeration appliance door by the at least one evaluation unit. In the function adjustment step 36b, the power, for example, in the case of a contact of the plunger with the at least one refrigeration appliance door being identified within the at least one analysis step 26b of the method 10b or in the case of an identified opening of the at least one refrigeration appliance door, the power of a compressor of the refrigeration appliance, could be increased from an initial value, which is not equal to a maximum value, to, for example, the maximum value of the power in order to counteract, in particular, disadvantageous heating of the reception space of the refrigeration appliance. Alternatively or additionally, it would be conceivable that, in the at least one function adaptation step 36b, an operating program, for example a cooling program is interrupted or activated as a function of the determined position of the at least one plunger and/or the position of the at least one refrigeration appliance door. Alternatively or additionally, it would be conceivable that, in the at least one function adaptation step 36b of the method 10b, a function or an operating program of the refrigeration appliance is made inaccessible or non-executable for an operator as a function of the determined position of the at least one plunger and/or the position of the at least one refrigeration appliance door.

For further features of the method 10b, reference is made to FIGS. 1 to 4 and their description.

FIG. 6 illustrates a schematic flow diagram of a method 10c for operating a door opening apparatus for a refrigeration appliance, in particular a refrigerator. The method 10c has at least one detection step 20c for detecting a pressure within the refrigeration appliance, in particular within the at least one interior space of the refrigeration appliance, by the at least one sensor unit of the door opening apparatus. In at least one door opening step 46c of the method 10c, a refrigeration appliance door of the refrigeration appliance is opened by at least one plunger of the door opening apparatus. In at least one calculating step 48c of the method 10c, a sliding mean value of the detected pressure is formed by at least one evaluation unit of the door opening apparatus in order to determine at least one pressure threshold value for determining a position of at least one plunger of the door opening apparatus. The sliding mean value of the detected pressure formed in the at least one calculating step 48c is used as a pressure reference value for determining the at least one pressure threshold value in at least one pressure threshold value determination step 50c of the method 10c. In the present case, the pressure threshold value determination step 50c is performed after each calculating step 48c in order to dynamically determine in particular the at least one pressure threshold value as a function of the sliding mean value of the detected pressure. The method 10c has at least one analysis step 26c in which, as a function of the detected pressure, the at least one position of the at least one plunger of the door opening apparatus is determined by the evaluation unit. Moreover, in the at least one analysis step 26c opening and/or closing the refrigeration appliance door is determined as a function of the detected pressure by the at least one evaluation unit. The method 10c has at least one query step 54c. In the at least one query step 54c of the method 10c, the at least one evaluation unit checks whether a specific instruction is present for a result of the at least one analysis step 26c. If a specific instruction is not present, the at least one detection step 20c, the at least one calculating step 48c, the at least one pressure threshold value determination step 50c and the at least one analysis step 26c are repeated. If a specific instruction for the result of the at least one analysis step 26c is present, the at least one evaluation unit executes it. At least one specific instruction is stored in a storage facility of a storage facility unit of the at least one evaluation unit at least for the result of an identified contact of the at least one plunger with the at least one refrigeration appliance door. If, for example, a contact position of the at least one plunger with the at least one refrigeration appliance door is identified, the at least one specific instruction causes the at least one evaluation unit, for example, to trigger at least one movement adaptation step 38c of the method 10c for regulating at least one movement parameter of the at least one plunger. In the at least one movement adaptation step 38c, the at least one movement parameter of the at least one plunger is regulated as a function of the at least one determined position of the at least one plunger.

In the at least one movement adaptation step 38c of the method 10c, in the present case a movement speed of the at least one plunger when retracting and/or extending the plunger is regulated as a function of the determined position of the at least one plunger by the at least one evaluation unit. It is preferred that, in the at least one movement adaptation step 38c, the movement speed of the at least one plunger is regulated to a value of 30% of a maximum movement speed of the at least one plunger when the at least one plunger is in a position not in contact with the at least one refrigeration appliance door. It is preferred that, in the at least one movement adaptation step 38c, the movement speed of the at least one plunger is regulated to a value of 85% of the maximum speed of the at least one plunger in the case of an identified contact of the at least one plunger with the at least one refrigeration appliance door. When the at least one door opening step 46c is completed, the at least one evaluation unit initiates at least one plunger retraction step of the method 10c in the at least one query step 54a, wherein, in the at least one movement adaptation step 38c, the speed of the plunger is regulated to a value of, for example, 100% of the maximum speed of the at least one plunger.

For further features of the method 10c, reference is made to FIGS. 1 to 5 and their description.

FIG. 7 illustrates a schematic representation of a refrigeration appliance 712. In the present case, the refrigeration appliance 712 is configured as a refrigerator. Alternatively, however, other embodiments of the refrigeration appliance 712 would also be conceivable, such as for example as an upright freezer or as a chest freezer.

The refrigeration appliance 712 has at least one body 726. The at least one body 726 forms an outer housing of the refrigeration appliance 712. The refrigeration appliance 712 has at least one inner container 752. The at least one inner container 752 delimits at least one interior space 716 of the refrigeration appliance 712. The at least one inner container 752 is accommodated in the at least one body 726. The at least one inner container 752 and the at least one body 726 are configured separately from one another in the present case. The refrigeration appliance 712 has at least one refrigeration appliance door 728 for closing the interior space 716. The at least one inner container 752 has a plurality of walls. The inner container 752 has a rear wall 754, which is disposed in particular lying opposite an opening of the body 726 which can be closed by the refrigeration appliance door 728. Moreover, the inner container 752 has a base wall 756, a ceiling wall 758, a side wall and a further side wall. The at least one interior space 716 is delimited by the walls of the at least one inner container 752. In the present case, the at least one inner container 752 is made at least in part, in particular completely, of at least a synthetic material. Alternatively, however, it would also be conceivable that the at least one inner container 752 is made at least in part, in particular completely, from a metal or a composite material. A thermally insulating material, in particular a thermally insulating foam, is inserted (not illustrated) in an intermediate space 760 between the at least one body 726, in particular the outer housing, and the at least one inner container 752, in particular the walls of the inner container 752, preferably on the side of the at least one inner container 752 remote from the at least one interior space 716.

The at least one interior space 716 of the refrigeration appliance 712 has a reception region 762. The reception region 762 is provided so as to receive and cool, for example, goods to be stored, for example food stuffs, which are placed into at least one reception region 762 by an operator. The goods to be stored can be stored by at least one storage compartment and/or storage container and/or storage shelves. The refrigeration appliance 712 has at least one refrigerant circuit 764 for cooling the at least one interior space 716 of the refrigeration appliance 712. The at least one refrigerant circuit 764 has at least one evaporator 766. The at least one refrigerant circuit 764 has at least one condenser 768. The at least one refrigerant circuit 764 has at least one compressor 770.

The at least one evaporator 766 of the at least one refrigerant circuit 764 is disposed on the side of the rear wall 754 of the at least one inner container 752 facing the at least one interior space 716. The refrigeration appliance 712 has at least one separating element 774 in order to separate the at least one interior space 716 into a further region, namely an evaporator region 772. The at least one separating element 774 separates the reception region 762 and the evaporator region 772 spatially from one another. In particular, the separating element 774 has recesses and/or air channels in order to exchange air between the evaporator region 772 and the reception region 762, in particular for cooling the reception region 762. At least one fan 776 and at least one further fan are disposed in the evaporator region 772 in order to exchange an advantageously large amount of air and/or to guide air in an advantageously purposeful manner between the evaporator region 772 and the reception region 762.

The at least one refrigeration appliance door 728 is provided so as to counteract, in particular prevent, heat or cold or fluids escaping from the at least one interior space 716 of the refrigeration appliance 712 or dust or foreign bodies entering the at least one interior space 716, in particular in the reception region 762 of the refrigeration appliance 712.

The refrigeration appliance 712 has at least one hinge element (not illustrated). The at least one refrigeration appliance door 728 is connected to the at least one body 726 by the at least one hinge element. The at least one hinge element defines a fastening axis, in particular a pivot axis, so as to open and/or close the refrigeration appliance door 728.

The refrigeration appliance 712 has at least one magnetic sealing element 778. The at least one magnetic sealing element 778 is disposed in the present case on the at least one refrigeration appliance door 728. The at least one sealing element 778 is provided so as to seal the at least one interior space 716 of the refrigeration appliance 712 closed by the at least one refrigeration appliance door 728 with respect to a space located outside the refrigeration appliance 712. The at least one magnetic sealing element 778 is provided so as, in particular in a state of the at least one interior space 716 closed by the at least one refrigeration appliance door 728, to maintain a leakage rate below a limit value specifically set for the refrigeration appliance 712 configured as a refrigerator in order to fulfill, for example, the standard according to ISO 15502 or EN 62552.

The refrigeration appliance 712 includes at least one door opening unit 780. The at least one door opening unit 780 has at least one drive unit (not illustrated). The at least one door opening unit 780 is disposed at least in part within the intermediate space 760 between the at least one body 726 of the refrigeration appliance 712 and the at least one inner container 752, in particular the base wall 756 of the at least one inner container 752, of the refrigeration appliance 712. Alternatively, it would also be conceivable that the at least one door opening unit 780 is disposed at least in part on the at least one body 726, in particular the outer housing of the refrigeration appliance 712. Alternatively, however, it would also be conceivable that the at least one door opening unit 780 is disposed in the intermediate space 760 between the at least one body 726 and the side wall of the inner container 752 or the ceiling wall 758 of the inner container 752. Alternatively, it would moreover be conceivable that the at least one door opening unit 780 is disposed on or at least in part within the at least one refrigeration appliance door 728.

The at least one door opening unit 728 includes at least one a plunger 782 that can be driven by the at least one drive unit so as to open the at least one refrigeration appliance door 728. The at least one drive unit of the at least one door opening unit 780 is provided to retract and/or extend the at least one plunger 782 in order to open in particular the at least one refrigeration appliance door 728.

The refrigeration appliance 712 includes at least one door monitoring apparatus 710. The at least one door monitoring apparatus 710 is disposed within the at least one body 726 of the refrigeration appliance 712. In particular, the at least one door monitoring apparatus 710 is disposed at least in part within the at least one interior space 716, advantageously at least in part within the evaporator region 772.

The at least one door monitoring apparatus 710 has at least one, in particular digital, pressure sensor 714 for detecting a pressure within the at least one interior space 716 of the refrigeration appliance 712. The at least one pressure sensor 714 is configured in the present case as a MEMS-based barometric pressure sensor. The at least one pressure sensor 714 is provided so as to detect an absolute air pressure within the interior space 716 of the refrigeration appliance 712. Alternatively, however, it would also be conceivable that the at least one pressure sensor is configured as a piezo-resistive pressure sensor or as a capacitive pressure sensor or as a resonance pressure sensor or as an optical pressure sensor or as a ceramic pressure sensor. The at least one door pressure sensor 714 is disposed in the present case within the at least one interior space 716, in particular within the evaporator region 772. The at least one pressure sensor 714 is provided so as in particular to detect the pressure with a scanning rate of at least 16 Hz, in the present case of precisely 20 Hz.

The at least one door monitoring apparatus 710 includes at least one evaluation unit 718 for analyzing the detected pressure. The at least one evaluation unit 718 can be configured as a microcontroller or a microprocessor. The at least one evaluation unit 718 is disposed in the present case within the at least one interior space 716, in particular within the evaporator region 772. The at least one evaluation unit 718 includes at least one evaluation program in order to evaluate the detected pressure. The at least one evaluation unit 718 is provided so as to identify a door opening request, in particular for opening the at least one refrigeration appliance door by the at least one door opening unit 780 as a function of the detected pressure. The at least one evaluation unit 718 is provided so as to identify opening the at least one refrigeration appliance door 728 of the refrigeration appliance 712 as a function of the detected pressure. The at least one evaluation unit 718 is provided so, as a function of the detected pressure, to identify closing the at least one refrigeration appliance door 728 of the refrigeration appliance 712 as a function of the detected pressure.

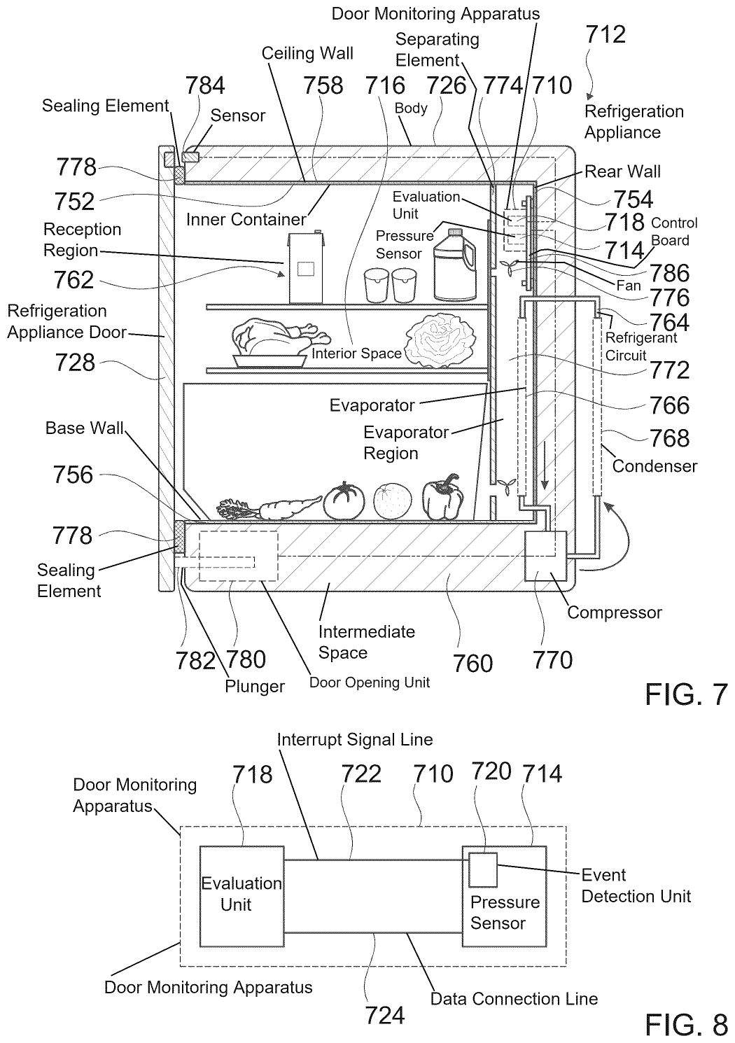

The at least one door monitoring apparatus 710 includes at least one event detection unit 720 (cf. FIG. 8). The at least one event detection unit 720 connects the at least one pressure sensor 714 and the at least one evaluation unit 718 to one another in terms of signal technology. The at least one event detection unit 720 is integrated in the present case at least in part in the at least one pressure sensor 714. The at least one pressure sensor 714 has control electronics. The at least one event detection unit 720 forms at least in part the control electronics of the at least one pressure sensor 714. Alternatively, it is conceivable that the at least one event detection unit 720 includes at least one comparator, for example a comparator circuit, which is disposed in particular in terms of circuit technology between the at least one pressure sensor 714 and the at least one evaluation unit 718.

The at least one event detection unit 720 has at least one interrupt signal line 722, which leads from the at least one pressure sensor 714 to the at least one evaluation unit 718 (cf. FIG. 8). The at least one evaluation unit 718 includes at least one interrupt input pin (not illustrated). The at least one pressure sensor 714, in particular the control electronics of the at least one pressure sensor 714 has at least one interrupt output pin (not illustrated). The at least one interrupt signal line 722 leads from the at least one interrupt output pin of the at least one pressure sensor 714 to the at least one interrupt input pin of the at least one evaluation unit 718.

The at least one door monitoring apparatus 710 has at least one data connection line 724 for transmitting data of the at least one pressure sensor 714 to the at least one evaluation unit 718. The at least one data connection line 724 is configured in the present case as a I2C data connection line (inter-integrated circuit). In particular, the at least one evaluation unit 718 and the at least one pressure sensor 714 have a corresponding communication interface (not illustrated). Alternatively, it is conceivable that the at least one data connection line 724 is configured, for example, as an SPI-data connection line (serial peripheral interface) or as an UART-data connection line (universal asynchronous receiver-transmitter) or as a CAN-data connection line (controller area network) or as a 1-Wire-data connection line or as a Modbus-connection line or as a BLE-data connection line (Bluetooth low energy) or the like.

The at least one event detection unit 720 is provided so as, as a function of the detected pressure, to activate the at least one evaluation unit 718 from an energy saving mode. The at least one event detection unit 720 is provided so as to monitor the detected pressure. The at least one event detection unit 720 is provided so as to compare the detected pressure with an activation pressure threshold value 740. The at least one event detection unit 720 is provided so as to send an activation signal, in particular an interrupt signal, via the at least one interrupt signal line 722 to the at least one evaluation unit 718 if the detected pressure exceeds the activation pressure threshold value 740 in order to wake up in particular the at least one evaluation unit 718 from the energy saving mode.

The at least one door monitoring apparatus 710 includes at least one sensor 784 for detecting a position parameter of the at least one refrigeration appliance door 28 (cf. FIG. 7). The at least one sensor 784 for detecting the position parameter of the at least one refrigeration appliance door 728 is configured as a magneto-resistive sensor in the present case. The at least one sensor 784 includes at least one magnetic element which is disposed on the at least one refrigeration appliance door 728 (cf. FIG. 7). The at least one sensor 784 includes at least one electronic control device for processing the detected position parameter. Alternatively, it is conceivable that the at least one sensor 784 for detecting the position parameter of the at least one refrigeration appliance door 728 is configured as a Hall-effect sensor or as an infrared sensor or as a capacitive proximity sensor or as an inductive proximity sensor or as a rotary angle sensor or as an ultrasound sensor or as a contact switch. In particular, the at least one sensor 784 for detecting the position parameter of the at least one refrigeration appliance door 728 is connected to the at least one evaluation unit 718 in terms of signal technology.

The refrigeration appliance 712 includes at least one control unit. The at least one control unit is provided at least so as to control the at least one door opening unit 780. In particular, the at least one control unit is additionally provided so as to control and/or regulate multiple components of the refrigeration appliance 712, for example actuation of an illuminating device of the refrigeration appliance 712 or actuation of the at least one refrigerant circuit 764, preferably of the compressor 770, of the refrigeration appliance 712, or actuation of the at least one fan 776. The at least one control unit includes at least one control board 786 (cf. FIG. 7). The at least one control board 786 is disposed in the present case on the rear wall 754 of the at least one inner container 752, in particular on a side of the rear wall 754 facing the at least one interior space 716. The at least one door monitoring apparatus 710 is integrated at least in part in the at least one control unit of the refrigeration appliance 712. The at least one door monitoring apparatus 710 is disposed at least in part on the at least one control board 786. In the present case, the at least one evaluation unit 718 is disposed on the at least one control board 786. In the present case, the at least one pressure sensor 718 is disposed on the at least one control board 786. In particular, the at least one event detection unit 720 is disposed on the at least one control board 786.

In the figures, in each case only one of the multiple provided objects is provided with a reference character.

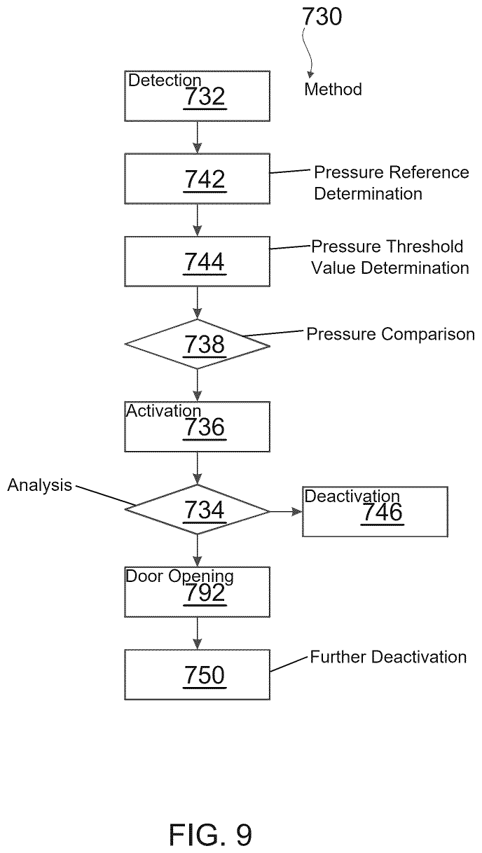

FIG. 9 shows a schematic flow diagram of a method 730 for operating the at least one door monitoring apparatus 710 of the refrigeration appliance 712.

The method 730 includes at least one door detection step 732. In the at least one detection step 732, a pressure is detected in the at least one interior space 716 of the refrigeration appliance 712 by the at least one pressure sensor 714. In the at least one detection step 732, an absolute pressure is detected in the at least one interior space 716 by the at least one pressure sensor 714. Alternatively, it is conceivable that, in the at least one detection step 732, a relative pressure or a differential pressure is detected, in particular relative to an atmospheric pressure at the installation site of the refrigeration device 712. In the at least one detection step 732, the pressure in the at least one interior space 716 is detected in the present case with a scanning rate of 20 Hz.

The method 730 includes at least one pressure reference determination step 742 which is performed by the at least one evaluation unit 718 and/or the at least one pressure sensor 714, in particular by the at least one event detection unit 720. A sliding mean value of the detected pressure is formed in the at least one pressure reference determination step 742. In the present case, the sliding mean value of the last four values of the detected pressure is formed in the at least one pressure reference determination step 742.

The sliding mean value of the detected pressure formed in the at least one pressure reference determination step 742 is used as a pressure reference value for determining the at least one pressure threshold value in at least one pressure threshold value determination step 744 of the method 730. The at least one pressure threshold value determination step 744 is performed in particular by the at least one evaluation unit 718 and/or the at least one event detection unit 720, in particular by the at least one event detection unit 720. In the present case, the pressure threshold value determination step 744 is performed after each pressure reference determination step 742 in order to determine and/or update in particular the at least one pressure threshold value as a function of the pressure reference value, in particular of the sliding mean value of the detected pressure, during operation of the refrigeration appliance 712.

In at least one further detection step of the method 730, the at least one position parameter of the at least one refrigeration appliance door 728 is detected (not illustrated) in particular by the at least one sensor 784 for detecting the position parameter of the at least one refrigeration appliance door 728. In at least one interior space state determination step of the method 730, in particular by the control electronics of the at least one sensor 784, a state of the at least one interior space 716 opened by the at least one refrigeration appliance door 728 and/or closed by the at least one refrigeration appliance door 728 is identified (not illustrated) as a function of the detected position parameter of the at least one refrigeration appliance door 728. As a function of the detected position parameter of the at least one refrigeration appliance door 728, an open signal or a closed signal is sent to the at least one evaluation unit 718 and/or the at least one event detection unit 720 in the at least one interior space state determination step. In the present case, the at least one position parameter of the at least one refrigeration appliance door 728 includes a resistance signal. A state of the at least one interior space 716 opened by the at least one refrigeration appliance door 728 can be identified in at least one inner space state determination step if, for example, the resistance signal detected by the sensor 784, in particular the magneto resistive sensor, corresponds to at least 90% of an original resistance value. If a state of the at least one interior space 716 opened by the at least one refrigeration appliance door 728 is identified as a function of the at least one position parameter of the at least one refrigeration appliance door 728, the sensor 784 sends the open signal to the at least one evaluation unit 718 and/or the at least one event detection unit 720. In particular, in the at least one interior space state determination step, a state of the at least one interior space 716 closed by the at least one refrigeration appliance door 728 can be identified if the resistance signal detected by the magneto resistive sensor is less than 90% of the original resistance value. If a state of the at least one interior space 716 closed by the at least one refrigeration appliance door 728 is identified as a function of the at least one position parameter of the at least one refrigeration appliance door 728, the sensor 784 sends the closed signal to the at least one evaluation unit 718 and/or the at least one event detection unit 720.

In the present case, the at least one pressure reference determination step 742 of the method 730 for forming the sliding mean value of the detected pressure is only performed if a state of the at least one interior space 718a closed by the at least one refrigeration appliance door 728 is identified as a function of the detected position parameter of the at least one refrigeration appliance door 728 in the at least one interior space state determination step. In particular, when the open signal is present, the determined pressure reference value remains at the value of the sliding mean value of the detected pressure last formed in the at least one pressure reference determination step 742.

In the at least one pressure threshold value determination step 744, the activation pressure threshold value 740 is set at a value which deviates from the sliding mean value of the detected pressure by a minimum 2 Pa and/or a maximum 8 Pa. In the present case, the activation pressure threshold value 740 is set in the at least one pressure threshold value determination step 744 at 4 Pa greater than the sliding mean value.

In the at least one pressure threshold value determination step 744, an opening pressure threshold value 748 is set at a value which deviates from the actuation pressure threshold value by a minimum 2 Pa and/or a maximum 8 Pa. In the present case, the opening pressure threshold value is set at 4 Pa greater than the activation pressure threshold value 740.

In the at least one pressure threshold value determination step 744, further pressure threshold values are determined, such as for example a door closing pressure threshold value 788 for identifying closing the at least one refrigeration appliance door 728 and/or a door opening pressure threshold value 790 for identifying opening the at least one refrigeration appliance door 728 by the at least one door opening unit 780 and/or a further door opening pressure threshold value for identifying opening the at least one refrigeration appliance door 728 by a user and/or a door gap pressure threshold value for identifying a door gap.

In at least one pressure comparison step 738 of the method 730, the detected pressure is compared by the at least one event detection unit 720 with the activation pressure threshold value 740. If, in the at least one pressure comparison step 738, it is identified that the detected pressure exceeds the activation pressure threshold value 740, at least one activation step 736 is initiated. In the at least one activation step 736, the at least one evaluation unit 718 for evaluating the detected pressure is activated from an energy saving mode by the at least one event detection unit 720 as a function of the detected pressure. The at least one event detection unit 720 generates an activation signal, in particular an interrupt signal, in the at least one activation step 736 as a function of the detected pressure, in particular as a function of an identified exceeding of the activation pressure threshold value 740. The activation signal, in particular the interrupt signal, is sent from the at least one event detection unit 720, in particular via the interrupt output pin, to the at least one evaluation unit 718, in particular to the at least one interrupt input pin. The at least one interrupt input pin triggers an interrupt when the activation signal is present in order to activate the at least one evaluation unit 718 from the energy saving mode. The at least one activation step 736 initiates at least one analysis step 34 for analyzing the detected pressure by the at least one evaluation unit 718.

In the at least one analysis step 34, the detected pressure is evaluated by the at least one evaluation unit 718. In the at least one analysis step 34, a door opening request is identified as a function of the pressure progression above the opening pressure threshold value 748. In the present case, a door opening request is identified in the at least one analysis step 34 if a period of time between a point in time of exceeding the opening pressure threshold value 748 and another point in time of falling below the opening pressure threshold value 748 by a minimum 0.1 s and a maximum 0.8 s is detected. If a door opening request is identified in the at least one analysis step 34, the at least one evaluation unit 718 initiates at least one door opening step 792 of the method 730 for opening the at least one refrigeration appliance door 728 by the at least one door opening unit 780. It is conceivable that the at least one door opening step 792 is initiated with a time delay of for example a maximum 5 s, advantageously a maximum 4 s, particularly advantageously a maximum 3 s, preferably a maximum 2 s, particularly preferably a maximum 1 s after a door opening request has been identified in the at least one analysis step 34.

In at least one deactivation step 746 of the method 730, the at least one evaluation unit 718 is switched, in particular by the at least one evaluation unit 718, into the energy saving mode as a function of a pressure progression above the opening pressure threshold value 748. In the present case, the at least one deactivation step 746 is initiated if, in the at least one analysis step 34, a door opening request is not identified as a function of the pressure progression above the opening pressure threshold value 748. The at least one deactivation step 746 is initiated if a door opening request is not identified in the at least one analysis step 34 within a time period of at least 2 s, in particular of at least 3 s, advantageously of at least 4 s, preferably of at least 5 s, and a maximum 10 s after the start of the at least one analysis step 34, in particular after the point in time of exceeding the activation pressure threshold value 740.

In at least one further deactivation step 750 of the method 730, the at least one evaluation unit 718 is switched into the energy saving mode in particular by the at least one evaluation unit 718 if, in the at least one analysis step 34, a state of the at least one interior space 716 of the refrigeration appliance 712 closed by the at least one refrigeration appliance door 728 is identified, in particular after opening the at least one refrigeration appliance door 728 by a user and/or the at least one door opening unit 780.

The state of the at least one interior space 716 of the refrigeration appliance 712 closed by the at least one refrigeration appliance door 728 is identified in the at least one analysis step 34 as a function of the detected pressure. In the at least one analysis step 34, opening the at least one refrigeration appliance door 728 by a user and/or by the at least one door opening unit 780 is identified as a function of the detected pressure. In the at least one analysis step 34, the opening of the at least one refrigeration appliance door 728 by a user can be identified if the further door opening pressure threshold value is fallen below and exceeded again within a time period of, for example, a minimum 0.1 s and a maximum 0.8 s. In the at least one pressure threshold value determination step 744, the further opening threshold value is set for example at 20 Pa less than the sliding mean value of the detected pressure. In the at least one analysis step 34, the opening of the at least one refrigeration appliance door 728 by the at least one door opening unit 780 is identified, in particular after the at least one door opening step 792 is initiated, if the detected pressure falls below and exceeds again the door opening pressure threshold value 790 within a time period in the present case of a minimum 0.1 s and a maximum 1 s. In the at least one pressure threshold value determination step 744, the door opening threshold value 790 is set in the present case at 10 Pa less than the sliding mean value of the detected pressure. In the at least one analysis step 34, closing the at least one refrigeration appliance door 728 is identified as a function of the detected pressure. In the at least one analysis step 34, the closing of the at least one refrigeration appliance door 728 is identified if the detected pressure falls below and exceeds again the door closing pressure threshold value 788 within a time period in the present case of a minimum 0.1 s and a maximum 1 s. In the at least one pressure threshold value determination step 744, the door closing threshold value 788 is set in the present case at 20 Pa greater than the sliding mean value of the detected pressure. The state of the at least one interior space 716 closed by the at least one refrigeration appliance door 728 is identified in the at least one analysis step 34 as a function of the detected pressure if, after identifying opening the at least one refrigeration appliance door 728, closing the refrigeration appliance door 728 is identified. Alternatively or additionally, it is conceivable that the state of the at least one interior space 716 closed by the at least one refrigeration appliance door 728 is identified as a function of the detected position parameter of the at least one refrigeration appliance door 728. In particular, the state of the at least one interior space 716 closed by the at least one refrigeration appliance door 728 is identified as a function of the detected position parameter of the at least one refrigeration appliance door 728 if the closed signal follows the open signal sent by the at least one further sensor 784. The at least one evaluation unit 718 preferably checks in the at least one analysis step 34 whether the detected position parameter of the refrigeration appliance door 728, in particular the sent open signal and/or closed signal, correlates with the detected pressure in order to confirm an evaluation of the detected pressure. It is conceivable that the at least one further deactivation step 750 is initiated with a time delay of at least 2 s, in particular of at least 3 s, advantageously of at least 4 s, preferably of at least 5 s, and a maximum 10 s after the identification of the state of the at least one interior space 716 closed by the at least one refrigeration appliance door 728 in order to still further analyze in particular the detected pressure.

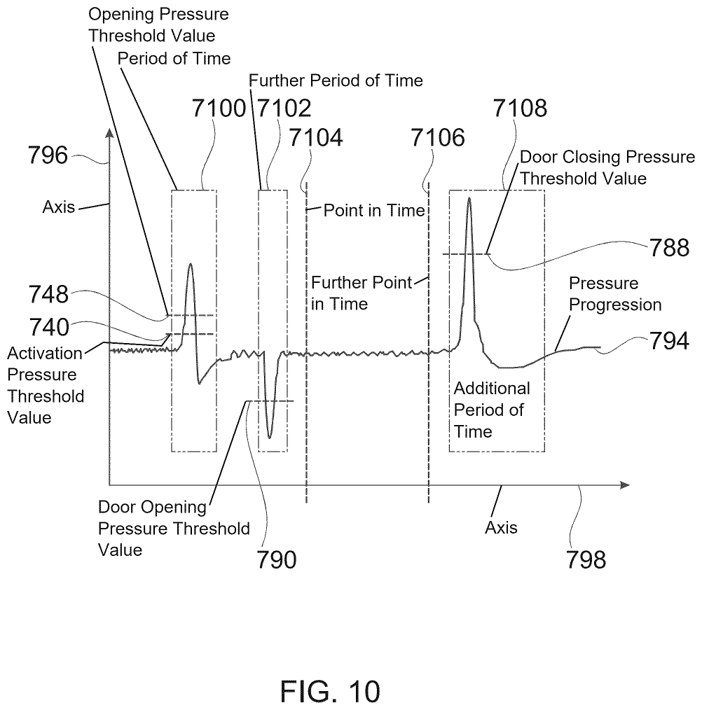

FIG. 10 shows a time-pressure diagram for describing an exemplary pressure progression 794 during the course of the method 730. The pressure progression 794 describes an absolute pressure in the at least one interior space 716 of the refrigeration appliance 712 detected by the at least one sensor unit 714 in the at least one detection step 732 as a function of time. The detected absolute pressure is plotted on an axis 796 over an axis 798 of time.

The pressure progression 794 starts with an at least basically constant pressure which corresponds at least basically to the atmospheric pressure at the installation site of the refrigeration appliance 712. The at least one interior space 716 is in a state closed by the at least one refrigeration appliance door 728.

A sliding mean value of the detected pressure is determined in the at least one pressure reference determination step 742 of the method 730. The sliding mean value of the detected pressure is used as a pressure threshold value. In the at least one pressure threshold value determination step 744, the activation pressure threshold value 740 and the opening pressure threshold value 748 are determined as a function of the pressure reference value, in particular as a function of the sliding mean value of the detected pressure. In the at least one pressure threshold value determination step 744, the activation pressure threshold value 740 is set at 4 Pa greater than the pressure reference value. In the at least one pressure threshold value determination step 744, the opening pressure threshold value 748 is set at 4 Pa greater than the activation pressure threshold value 740. In the at least one pressure threshold value determination step 744, the door opening pressure threshold value 790 and the door closing pressure threshold value 788 are determined as a function of the pressure reference value, in particular as a function of the sliding mean value of the detected pressure. In the at least one pressure threshold value determination step 744, the door opening pressure threshold value 790 is set at 10 Pa less than the pressure reference value. In the at least one pressure threshold value determination step 744, the door closing pressure threshold value 788 is set at 20 Pa greater than the pressure reference value, in particular the sliding mean value of the detected pressure.

In a period of time 7100, a user exerts a pushing force on the at least one refrigeration appliance door 728, for example by pushing for a short time against the at least one refrigeration appliance door 728. A pressure change in the at least one interior space 716 of the refrigeration appliance 712 is generated by a pushing force exerted by the user on the at least one refrigeration appliance door 728. In particular, by using the pushing force exerted on the at least one refrigeration appliance door 728, the at least one sealing element 778 of the refrigeration appliance 712 compresses, resulting in a volume of the at least one interior space 716 reducing and an increase in pressure. If the user does not exert any more pushing force on the at least one refrigeration appliance door 728, the at least one sealing element 778 expands again, resulting in the volume of the interior space 716 increasing again, which in turn generates a drop in pressure.

In the at least one pressure comparison step 738 of method 730, exceeding the activation pressure threshold value 740 is identified by the at least one event detection unit 720. The at least one event detection unit 720 generates an activation signal, in particular an interrupt signal, which is sent to the at least one evaluation unit 718 in order to activate the evaluation unit 718 from the energy saving mode. The at least one evaluation unit 718 initiates the at least one analysis step 734. In the at least one analysis step 734, the detected pressure is evaluated by the at least one evaluation unit 718.

For the period of time 7100, it is identified in the at least one analysis step 734 that at least one a pressure value exceeds the opening pressure threshold value 748. In the at least one analysis step 734, it is additionally identified that a period of time between a point in time of exceeding the opening pressure threshold value 748 and a point in time of falling below the opening pressure threshold value 748 is greater than 0.1 s and less than 1 s. In the at least one analysis step 734, a door opening request is identified for the period of time 7100. On the basis of identifying the door opening request, the at least one evaluation unit 718 triggers the at least one door opening step 792 so as to open the at least one refrigeration appliance door 728. If, in the analysis step 734, a door opening request is not identified within a maximum period of time of 5 s after the initiation of the at least one analysis step 734, the at least one evaluation unit 718 initiates the at least one deactivation step 746 for switching the at least one evaluation unit 718 into the energy saving mode.

In a further period of time 7102, the door opening step 792 is performed so as to open the at least one refrigeration appliance door 728 by the at least one door opening unit 780. The at least one door opening unit 780 extends the at least one plunger 782 in order to open the at least one refrigeration appliance door 728. The at least one the plunger 782 exerts a pushing force on the at least one refrigeration appliance door 728, resulting in the at least one sealing element 778 expanding. The volume of the at least one interior space 716 is increased which in turn creates a drop in pressure in the at least one interior space 716. After a specific point, the sealing element 778 detaches from the at least one body 726 of the refrigeration appliance 712, whereby ambient air flows into the at least one interior space 716 which in turn increases the pressure in the at least one interior space 716. The detected pressure falls below and exceeds the door opening pressure threshold value 790 within a time period of a minimum 0.1 s and a maximum 1 s in the further period of time 7102, whereby the at least one evaluation unit 718 identifies opening the at least one refrigeration appliance door 728 for the further period of time 7102.

After completion of the at least one door opening step 792, the at least one refrigeration appliance door 728 can be opened further by a user. The user opens the at least one refrigeration appliance door 728 in order to place goods to be stored in the reception region 762 of the at least one interior space 716. By virtue of the user opening the at least one refrigeration appliance door 728 further, a state of the at least one interior space 716 opened by the at least one refrigeration appliance door 728 is identified in the at least one interior space state determination step at a point in time 7104 by the at least one sensor 784 as a function of position parameter of the at least one refrigeration appliance door 728. After a specific time, the user closes the at least one refrigeration appliance door 728. In the at least one interior space state determination step, a state of the at least one interior space 716 closed by the at least one refrigeration appliance door 728 is identified at a further point in time 7106 by the at least one sensor 784 as a function of the position parameter of the at least one refrigeration appliance door 728.

In an additional period of time 7108, the at least one sealing element 778 presses against the at least one body 726 as a result of the at least one refrigeration appliance door 728 closing. The at least one sealing element 778 is compressed, resulting in the volume of the at least one interior space 716 reducing and the pressure in the at least one interior space 716 increasing. The detected pressure exceeds and falls below the door closing pressure threshold value 788 within a time period of a minimum 0.1 s and a maximum 1 s in the additional period of time 7108, whereby, in the at least one analysis step 734, the at least one evaluation unit 718 identifies closing the at least one refrigeration appliance door 728 for the additional period of time 7108. In the at least one analysis step 734, by virtue of successively identifying the opening of the at least one refrigeration appliance door 728 and the closing of the at least one refrigeration appliance door 728, the state of the at least one interior space 716 closed by the at least one refrigeration appliance door 728 is identified as a function of the detected pressure. After identifying the state of the at least one interior space 716 closed by the at least one refrigeration appliance door 728 as a function of the detected pressure, the at least one evaluation unit 718 initiates the at least one further deactivation step 750 in order to switch the at least one evaluation unit 718 into the energy saving mode.

The following is a summary list of reference numerals and the corresponding structure used in the above description of the invention:
10 Method
12 Door opening apparatus
14 Refrigeration appliance
16 Plunger
18 Refrigeration appliance door
20 Detection step
22 Sensor unit
24 Interior space
26 Analysis step
28 Opening threshold value
30 Plunger position threshold value
32 Plunger movement step
34 Control step
36 Function adaptation step
38 Movement adaptation step
40 Drive unit
42 Evaluation unit
44 Inner container
46 Door opening step
48 Calculating step
50 Pressure threshold value determination step
52 Axis
54 Query step
56 Plunger retraction step
58 Output step
60 Pressure progression
62 Axis
64 Point in time
66 Sealing element
68 Further point in time
70 Region
72 Body
74 Side wall
76 Stop element
78 Intermediate space
80 Base wall
82 Housing unit
84 Control unit
710 Door monitoring apparatus
712 Refrigeration appliance
714 Pressure sensor
716 Interior space
718 Evaluation unit
720 Event detection unit
722 Interrupt signal line
724 Data connection line
726 Body
728 Refrigeration appliance door
730 Method
732 Detection step
734 Analysis step
736 Activation step
738 Pressure comparison step
740 Activation pressure threshold value
742 Pressure reference determination step
744 Pressure threshold value determination step
746 Deactivation step
748 Opening pressure threshold value
750 Further deactivation step
752 Inner container
754 Rear wall
756 Base wall
758 Ceiling wall
760 Intermediate space
762 Reception region
764 Refrigerant circuit
766 Evaporator
768 Condenser
770 Compressor
772 Evaporator region
774 Separating element
776 Fan
778 Sealing element
780 Door opening unit
782 Plunger
784 Sensor
786 Control board
788 Door closing pressure threshold value
790 Door opening pressure threshold value
792 Door opening step
794 Pressure progression
796 Axis
798 Axis
7100 Period of time
7102 Further period of time
7104 Point in time
7106 Further point in time
7108 Additional period of time

1. A method for operating a door opening apparatus for a refrigeration appliance, the method comprising:
providing the door opening apparatus, the door opening apparatus including an interior space, at least one refrigeration appliance door, and at least one plunger for opening the at least one refrigeration appliance door of the refrigeration appliance;
in at least one detection step, detecting a pressure in the interior space of the refrigeration appliance; and
in at least one analysis step, determining at least one position of the at least one plunger of the door opening apparatus as a function of the detected pressure.

2. The method according to claim 1, which further comprises using a sensor unit of the door opening apparatus for detecting the pressure in the interior space of the refrigeration appliance.

3. The method according to claim 1, which further comprises carrying out the at least one analysis step by at least one of:
determining a door opening position of the at least one plunger as a function of the detected pressure, or
determining a door opening position of the at least one plunger as a function of exceeding or crossing an opening threshold value, or
determining a door opening position of the at least one plunger as a function of a period of time between exceeding a pressure threshold value and a subsequent minimum of the detected pressure, or
moving the at least one plunger to a determined door opening position.

4. The method according to claim 1, which further comprises providing a spacing between one end of the at least one plunger and a contact surface of the at least one refrigeration appliance door to be at a maximum of 7 mm, in the door opening position of the at least one plunger.

5. The method according to claim 1, which further comprises carrying out at least one of:
at least one control step by monitoring at least one functional capability of the door opening apparatus as a function of the detected pressure, or
at least one function adaptation step by regulating a function of the refrigeration appliance as a function of the determined position of the at least one plunger, or
at least one movement adaptation step by regulating a movement parameter of the at least one plunger as a function of a determined position of the at least one plunger.

6. The method according to claim 5, which further comprises, in the at least one control step, monitoring the at least one functional capability of the door opening apparatus as an opening of the at least one refrigeration appliance door by the at least one plunger.

7. The method according to claim 1, which further comprises:
in the at least one detection step, detecting a pressure in the interior space of the refrigeration appliance;
in the at least one analysis step, evaluating the detected pressure; and
in at least one activation step, activating at least one evaluation unit for evaluating the detected pressure by using at least one event detection unit as a function of the detected pressure.

8. The method according to claim 7, which further comprises activating the at least one evaluation unit from an energy saving mode.

9. The method according to claim 7, which further comprises, in at least one pressure comparison step, comparing the detected pressure with an activation pressure threshold value, and when the at least one pressure comparison step identifies that the detected pressure exceeds the activation pressure threshold value, initiating the at least one activation step.

10. The method according to claim 7, which further comprises:
in at least one pressure reference determination step, forming a sliding mean value of the detected pressure; and
in at least one pressure threshold value determination step, determining an activation pressure threshold value as a function of the sliding mean value of the detected pressure formed in the at least one pressure reference determination step.

11. The method according to claim 10, which further comprises carrying out the step of determining the activation pressure threshold value dynamically.

12. The method according to claim 10, which further comprises setting the activation pressure threshold value to a value deviating from the sliding mean value of the detected pressure by at least one of a minimum of 2 Pa or a maximum of 8 Pa.

13. The method according to claim 12, which further comprises setting the activation pressure threshold value in the at least one pressure threshold value determination step.

14. The method according to claim 7, which further comprises, in at least one deactivation step:
switching the at least one evaluation unit into an energy saving mode as a function of a pressure progression above an opening pressure threshold value, or
switching the at least one evaluation unit into the energy saving mode, in the at least one analysis step, upon identifying a state of the at least one interior space of the refrigeration appliance as being closed by the at least one refrigeration appliance door.

15. A door opening apparatus for a refrigeration appliance, the door opening apparatus comprising:
at least one drive unit;
at least one plunger configured to be driven by said at least one drive unit for opening a refrigeration appliance door of the refrigeration appliance;
at least one sensor unit for detecting a pressure of an interior space of the refrigeration appliance; and
at least one evaluation unit for evaluating the detected pressure to determine a position of said at least one plunger.

16. A door opening apparatus for a refrigeration appliance, the door opening apparatus comprising:
at least one drive unit;
at least one plunger configured to be driven by said at least one drive unit for opening a refrigeration appliance door of the refrigeration appliance;
at least one sensor unit for detecting a pressure of an interior space of the refrigeration appliance; and
at least one evaluation unit for evaluating the detected pressure to determine a position of said at least one plunger, the at least one evaluation unit evaluating the detected pressure according to claim 1.

17. A door opening apparatus for a refrigeration appliance, the door opening apparatus comprising:
a door monitoring apparatus for the refrigeration appliance;
at least one pressure sensor for detecting a pressure within at least one interior space of the refrigeration appliance;
at least one evaluation unit for analyzing the detected pressure; and
at least one event detection unit interconnecting said at least one pressure sensor and said at least one evaluation unit in terms of signal technology, said at least one event detection unit configured to activate said at least one evaluation unit as a function of the detected pressure.

18. The door opening apparatus according to claim 17, wherein said at least one event detection unit is configured to activate said at least one evaluation unit from an energy saving mode.

19. The door opening apparatus according to claim 17, wherein:
said at least one event detection unit is integrated at least in part in said at least one pressure sensor, or
said at least one event detection unit has at least one interrupt signal line leading from said at least one pressure sensor to said at least one evaluation unit, or
at least one data connection line transmits data of said at least one pressure sensor to said at least one evaluation unit.

20. A refrigeration appliance, comprising:
an inner container delimiting an interior space;
at least one refrigeration appliance door for closing said interior space; and
at least one door opening apparatus according to claim 15.

21. The refrigeration appliance according to claim 20, which further comprises:
at least one body enclosing said inner container;
said at least one refrigeration appliance door being movable on said at least one body for closing said interior space; and
said at least one door opening apparatus being disposed within said at least one body.

22. A refrigeration appliance, comprising:
an inner container delimiting an interior space;
at least one refrigeration appliance door for closing said interior space; and
at least one door opening apparatus according to claim 17.

23. The refrigeration appliance according to claim 22, which further comprises:
at least one body enclosing said inner container;
said at least one refrigeration appliance door being movable on said at least one body for closing said interior space; and
said at least one door opening apparatus being disposed within said at least one body.
